(19) United States
(12) Patent Application Publication
(10) Pub. No.: US 2014/0247100 A1
(43) Pub. Date: Sep. 4, 2014

(54) R-T-B SINTERED MAGNET AND METHOD FOR PRODUCTION THEREOF, AND ROTARY MACHINE

(71) Applicant: TDK CORPORATION, Tokyo (JP)

(72) Inventors: Taeko Tsubokura, Tokyo (JP); Chikara Ishizaka, Tokyo (JP); Eiji Kato, Tokyo (JP); Tamotsu Ishiyama, Tokyo (JP); Nobuhiro Jingu, Tokyo (JP)

(73) Assignee: TDK CORPORATION, Tokyo (JP)

(21) Appl. No.: 14/350,728

(22) PCT Filed: Oct. 11, 2012
(86) PCT No.: PCT/JP2012/076327

§ 371 Date: Apr. 9, 2014

(30) Foreign Application Priority Data
Oct. 13, 2011 (JP) 2011-226040
Oct. 13, 2011 (JP) 2011-226042
Nov. 14, 2011 (JP) 2011-248978
Nov. 14, 2011 (JP) 2011-248980

(51) Int. Cl. H01F 1/057; H01F 41/02

(52) U.S. Cl. CPC H01F 1/0577; H01F 41/0266
USPC 335/302; 419/33

(57) ABSTRACT

An R-T-B sintered magnet 100 including particles containing an R₂T₁₄B phase, obtained using an R-T-B alloy strip containing crystal grains of an R₂T₁₄B phase, wherein the R-T-B alloy strip has, in a cross-section along the thickness direction, the crystal grains extending in a radial fashion from the crystal nuclei, the following inequality (1) being satisfied, where the average value of the lengths of the crystal grains on one side in the direction perpendicular to the thickness direction and the average value of the lengths on the other side opposite the one side are represented as D₁ and D₂, respectively, the mean particle diameter of the particles is 0.5 to 5 μm, and essentially no heavy rare earth elements are present.

0.9≦D₂/D₁≦1.1 (1)

### TECHNICAL FIELD

The present invention relates to an R-T-B sintered magnet and a method for its production, and to a rotary machine.

### BACKGROUND ART

For driving motors used in a variety of different fields, there is increasing demand for smaller sizes and lighter weights, as well as increased efficiency, in line with the goal of reducing installation space and lowering cost. Along with this demand there is a desire for techniques that allow further improvement in, for example, the magnetic properties of sintered magnets to be used in driving motors.

R-T-B rare earth sintered magnets have been used in the past as sintered magnets with high magnetic properties. It has been attempted to improve the magnetic properties of R-T-B sintered magnets using heavy rare earth metals such as Dy and Tb, which have large anisotropic magnetic fields H_{A}. However, with the rising costs of rare earth metal materials in recent years, there has been a strong desire to reduce the amount of usage of expensive heavy rare earth elements. In light of this situation, it has been attempted to improve magnetic properties by micronizing the structures of R-T-B sintered magnets.

Incidentally, R-T-B sintered magnets are produced by powder metallurgy methods. In production methods by powder metallurgy, first the starting material is melted and cast, to obtain an alloy strip containing the R-T-B based alloy. Next, the alloy strip is ground to prepare alloy powder having particle diameters of between several μm and several tens of μm. The alloy powder is then molded and sintered to produce a sintered compact. Next, the obtained sintered compact is worked to the prescribed dimensions. In order to improve the corrosion resistance, the sintered compact may be subjected to plating treatment if necessary to form a plating layer. It is thus possible to obtain an R-T-B sintered magnet.

In the production method described above, melting and casting of the starting material are usually accomplished by a strip casting method. A strip casting method is a method in which the molten alloy is cooled with a cooling roll to form an alloy strip. In order to improve the magnetic properties of R-T-B sintered magnets, it has been attempted to control the alloy structure by adjusting the cooling rate in the aforementioned strip casting method. For example, PTL 1 proposes obtaining an alloy strip comprising chill crystals, particulate crystals and columnar crystals with prescribed particle diameters, by a strip casting method.

### CITATION LIST

### Patent Literature

[PTL 1] Japanese Patent No. 3693838 specification

### SUMMARY OF INVENTION

### Technical Problem

With an alloy strip such as described in PTL 1, however, the shape and size variation of the alloy powder obtained by grinding the alloy strip is considerable. When such alloy powder is used to produce a sintered magnet, the non-uniform shapes and sizes of the alloy powder make it difficult to significantly improve the magnetic properties. Consequently, it is desirable to establish techniques that allow further improvement in the magnetic properties of R-T-B sintered magnets.

The coercive force (HcJ) and residual flux density (Br) of a sintered magnet have established relationships represented by the following formulas (I) and (II).

HcJ=α·H_{A}−N·Ms (I)

Br=Ms·(ρ/ρ₀)·f·A (II)

In formula (I), α is a coefficient representing the independence of the crystal grains, H_{A} represents the anisotropic magnetic field that is dependent on the structure, N represents the local demagnetizing field dependent on shape, etc., and Ms represents the saturation magnetization of the main phase. Also, in formula (II), Ms represents the saturation magnetization of the main phase, ρ represents the sintered density, ρ₀ represents the true density, f represents the volume ratio of the main phase, and A represents the degree of orientation of the main phase. Of these coefficients, H_{A}, Ms and f are dependent on the structure of the sintered magnet, and N is dependent on the shape of the sintered magnet. As clearly seen from formula (I), increasing α in formula (I) can increase the coercive force. This suggests that controlling the structure of the alloy powder used in the compact for a sintered magnet allows the coercive force to be increased. On the other hand, from the viewpoint of restrictions on resources and production costs, there is a demand for an R-T-B sintered magnet that allows high magnetic properties to be realized without using heavy rare earth elements.

The present invention has been accomplished in light of these circumstances, and its object is to provide an R-T-B sintered magnet having sufficiently excellent coercive force without using expensive and scarce heavy rare earth elements, as well as a method for its production.

### Solution to Problem

The present inventors have conducted much research centered on alloy strip structures with the aim of increasing the magnetic properties of R-T-B sintered magnets. As a result, we have found that by micronizing the structure of the alloy strip and increasing its homogeneity, the finally obtained R-T-B sintered magnet structure is micronized and R-rich phase segregation is inhibited, so that high magnetic properties can be stably obtained.

Specifically, the invention provides an R-T-B sintered magnet comprising particles containing an R₂T₁₄B phase, obtained using an R-T-B alloy strip containing crystal grains of an R₂T₁₄B phase, wherein the R-T-B alloy strip has crystal grains extending in a radial fashion from the crystal nuclei in a cross-section along the thickness direction, the following inequality (1) being satisfied, where the average value of the lengths of the crystal grains on one side in the direction perpendicular to the thickness direction and the average value of the lengths on the other side opposite the one side are represented as D₁ and D₂, respectively, the mean particle diameter of particles comprising the R₂T₁₄B phase in the R-T-B sintered magnet is 0.5 to 5 μm, and essentially no heavy rare earth elements are present. R represents a light rare earth element, T represents a transition element, and B represents boron.

0.9≦D₂/D₁≦1.1 (1)

The R-T-B sintered magnet of the invention employs an R-T-B alloy strip having the following structure, as a starting material. Specifically, the shapes of the R₂T₁₄B phase crystal grains in the R-T-B alloy strip do not extend in the direction perpendicular to the thickness direction of the R-T-B alloy strip, and variation in the shapes and widths of the crystal grains is sufficiently reduced. Usually when an R-T-B alloy strip is ground, the grain boundary phase, such as the R-rich phase at the grain boundaries of the R₂T₁₄B phase crystal grains, are preferentially fractured. The form of the alloy powder therefore depends on the shapes of the crystal grains of the R₂T₁₄B phase. The crystal grains of the R₂T₁₄B phase in the R-T-B alloy strip of the invention have sufficiently reduced variation in the columnar crystal shapes and widths, and it is thus possible to obtain an R-T-B alloy powder with sufficiently reduced variation in form and size. Thus, using such an R-T-B alloy strip allows an R-T-B sintered magnet to be obtained having minimized segregation of the R-rich phase as well as increased homogeneity of the microstructure.

In other words, the present invention does not employ a method of control by simply micronizing the crystal grains of the R₂T₁₄B phase in the R-T-B alloy strip, but rather controls the variation in the sizes and shapes of the R₂T₁₄B phase crystal grains to obtain a sharp structural distribution, and to increase the coercive force of the finally obtained R-T-B sintered magnet.

The R-T-B alloy strip preferably satisfies the following inequalities (2) and/or (3), where D_{AVE} and D_{MAX} are, respectively, the average value and maximum value for the lengths of the crystal grains in the direction perpendicular to the thickness direction, in the aforementioned cross-section.

1.0 μm≦D_{AVE}<3.0 μm (2)

1.5 μm≦D_{MAX}≦4.5 μm (3)

Since such an R-T-B alloy strip has sufficiently small widths of the crystal grains of the R₂T₁₄B phase and also sufficiently reduced variation in shapes, it can yield R-T-B alloy powder that is micronized and has sufficiently increased homogeneity of form and size. This further increases the homogeneity of the microstructure of the finally obtained R-T-B sintered magnet. As a result, the coercive force of the R-T-B sintered magnet can be further increased.

The R-T-B alloy strip of the invention contains an R-rich phase in which the R content is higher than the R₂T₁₄B phase based on mass, and the percentage of the number of R-rich phases with lengths of no greater than 1.5 μm in the direction perpendicular to the thickness direction in the cross-section, with respect to the total number of R-rich phases, is preferably 90% or greater. This allows an R-T-B alloy powder to be obtained that is even more micronized and has increased size homogeneity. As a result, the coercive force of the finally obtained R-T-B sintered magnet can be even further increased. An R-rich phase is a phase with a higher R content based on mass than the R₂T₁₄B phase.

The crystal grains of the R-T-B alloy strip are dendritic crystals, and preferably on at least one surface of the R-T-B alloy strip, the average value for the widths of the dendritic crystals is no greater than 60 μm, and the number of crystal nuclei in the dendritic crystals is at least 500 per 1 mm square area. The R-T-B alloy strip has at least a prescribed number of crystal nuclei per unit area on at least one surface. Such dendritic crystals have minimal growth in the in-plane direction of the R-T-B alloy strip. Therefore, R₂T₁₄B phases grow in a columnar fashion in the thickness direction. An R-rich phase is produced surrounding the R₂T₁₄B phases that have grown in a columnar fashion, and the R-rich phase fractures preferentially during grinding. Thus, grinding of an R-T-B alloy strip having such a structure can yield alloy powder in a uniformly dispersed state without segregation of the R-rich phase, compared to the prior art. Thus, firing such an alloy powder can minimize aggregation of the R-rich phase and abnormal grain growth of the crystal grains, to obtain an R-T-B sintered magnet having high coercive force.

The invention also provides a method for production of an R-T-B sintered magnet comprising particles containing an R₂T₁₄B phase, which has a step of grinding, molding and firing an R-T-B alloy strip, wherein the R-T-B alloy strip has crystal grains extending in a radial fashion from the crystal nuclei in a cross-section along the thickness direction, the following inequality (1) being satisfied, where the average value of the lengths of the crystal grains on one side in the direction perpendicular to the thickness direction and the average value of the lengths on the other side opposite the one side are represented as D₁ and D₂, respectively, the mean particle diameter of particles is 0.5 to 5 μm, and essentially no heavy rare earth elements are present. R represents a light rare earth element, T represents a transition element, and B represents boron.

0.9≦D₂/D₁≦1.1 (1)

In this production method there is employed an R-T-B alloy strip having the following structure, as a starting material. Specifically, the R-T-B alloy strip is such that the shapes of the R₂T₁₄B phase crystal grains do not extend in the direction perpendicular to the thickness direction of the R-T-B alloy strip, and variation in the shapes and widths of the crystal grains is sufficiently reduced. Consequently, it is possible to obtain an R-T-B alloy powder with sufficiently reduced variation in shapes and sizes. By using such R-T-B alloy powder it is possible to obtain an R-T-B sintered magnet having minimized segregation of the R-rich phase as well as increased homogeneity of the microstructure, and sufficiently high coercive force.

### Advantageous Effects of Invention

According to the invention it is possible to provide an R-T-B sintered magnet having sufficiently excellent coercive force without using expensive and scarce heavy rare earth elements, as well as a method for its production.

### BRIEF DESCRIPTION OF DRAWINGS

FIG. 1 is a perspective view of a preferred embodiment of an R-T-B sintered magnet of the invention.

FIG. 2 is a cross-sectional view schematically showing the cross-sectional structure of an R-T-B sintered magnet according to a preferred embodiment of the invention.

FIG. 3 is a schematic cross-sectional enlarged view showing the cross-sectional structure of an alloy strip used in production of an R-T-B sintered magnet according to the invention, along the thickness direction.

FIG. 4 is a schematic diagram of an apparatus to be used in a strip casting method.

FIG. 5 is an enlarged plan view showing an example of the roll surface of a cooling roll used for production of an alloy strip according to the invention.

FIG. 6 is a schematic cross-sectional view showing an example of the cross-sectional structure near the roll surface of a cooling roll used for production of an alloy strip according to the invention.

FIG. 7 is a schematic cross-sectional view showing an example of the cross-sectional structure near the roll surface of a cooling roll used for production of an alloy strip according to the invention.

FIG. 8 is a pair of SEM-BEI images (magnification: 350×) showing examples of cross-sections of an alloy strip to be used for production of an R-T-B sintered magnet, along the thickness direction.

FIG. 9 is a metallographic microscope image (magnification: 100×) of one surface of an R-T-B alloy strip to be used for production of an R-T-B sintered magnet of the invention.

FIG. 10 is a plan view schematically showing dendritic crystals in an R-T-B alloy strip to be used for production of an R-T-B sintered magnet according to the invention.

FIG. 11 is a metallographic microscope image (magnification: 1600×) of a cross-section of an R-T-B sintered magnet according to an embodiment of the invention.

FIG. 12 is a graph showing particle diameter distribution for particles containing a R₂T₁₄B phase in an R-T-B sintered magnet according to an embodiment of the invention.

FIG. 13 is a metallographic microscope image (magnification: 1600×) of a cross-section of a conventional R-T-B sintered magnet.

FIG. 14 is a graph showing particle diameter distribution for particles containing a R₂T₁₄B phase in a conventional R-T-B sintered magnet.

FIG. 15 is an illustration of the internal structure of a preferred embodiment of a motor according to the invention.

FIG. 16 is a metallographic microscope image (magnification: 100×) of one surface of the R-T-B alloy strip used in Example 1.

FIG. 17 is a metallographic microscope image (magnification: 100×) of one surface of the R-T-B alloy strip used in Example 2.

FIG. 18 is an SEM-BEI image (magnification: 350×) of a cross-section of the R-T-B alloy strip used in Example 5, along the thickness direction.

FIG. 19 is a metallographic microscope image (magnification: 100×) of one surface of the R-T-B alloy strip used in Comparative Example 1.

FIG. 20 is a metallographic microscope image (magnification: 100×) of one surface of the R-T-B alloy strip used in Comparative Example 2.

FIG. 21 is a metallographic microscope image (magnification: 100×) of one surface of the R-T-B alloy strip used in Comparative Example 3.

FIG. 22 is an SEM-BEI image (magnification: 350×) of a cross-section of the R-T-B alloy strip used in Comparative Example 3, along the thickness direction.

FIG. 23 is a diagram showing element map data for the rare earth sintered magnet of Example 10, with the triple point regions indicated in black.

FIG. 24 is a diagram showing element map data for the R-T-B sintered magnet of Comparative Example 5, with the triple point regions indicated in black.

### DESCRIPTION OF EMBODIMENTS

Preferred embodiments of the invention will now be explained with reference to the accompanying drawings where necessary. For the drawings, identical or corresponding elements will be referred to by like reference numerals and will be explained only once.

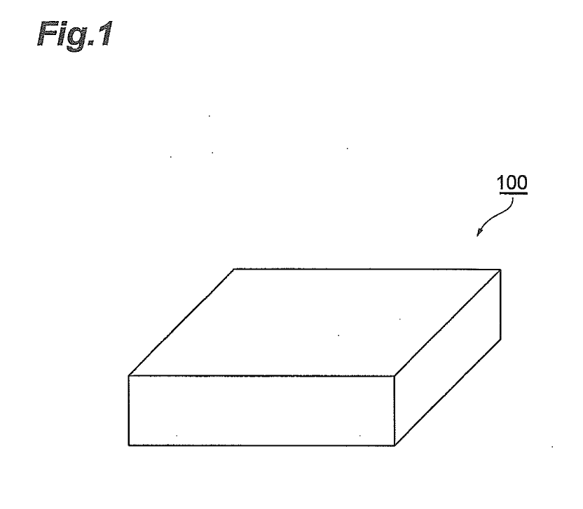

FIG. 1 is a perspective view of an R-T-B sintered magnet of this embodiment. The R-T-B sintered magnet 100 comprises R, B, Al, Cu, Zr, Co, O, C and Fe, the content ratios of each of the elements preferably being R: 26 to 35 mass %, B: 0.85 to 1.5 mass %, Al: 0.03 to 0.5 mass %, Cu: 0.01 to 0.3 mass %, Zr: 0.03 to 0.5 mass % and Co: ≦3 mass % (not including 0 mass %), O: ≦0.5 mass % and Fe: 60 to 72 mass %. Throughout the present specification, R represents a rare earth element and T represents a transition element. In the aforementioned content ratios, R may be 25 to 37 mass % and B may be 0.5 to 1.5 mass %.

The term “rare earth element”, for the purpose of the present specification, refers to scandium (Sc), yttrium (Y) and lanthanoid elements belonging to Group 3 of the long Periodic Table, the lanthanoid elements including, for example, lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb) and lutetium (Lu). Of these, Gd, Tb, Dy, Ho, Er, Tm, Yb and Lu are heavy rare earth elements, and Sc, Y, La, Ce, Pr, Nd, Sm and Eu are light rare earth elements.

The R-T-B sintered magnet 100 in this embodiment comprises a light rare earth element, but comprises essentially no heavy rare earth elements. Even essentially without using heavy rare earth elements, since an R-T-B alloy strip with a specific structure is used as the starting material, the homogeneity of the structure is improved and it exhibits sufficiently high magnetic properties.

The R-T-B sintered magnet 100 preferably comprises at least Fe as a transition element (T), and more preferably it comprises a combination of Fe and a transition element other than Fe. Transition elements other than Fe include Co, Cu and Zr. However, the R-T-B sintered magnet 100 may contain heavy rare earth elements as impurities of the starting material or impurities introduced as contaminants during production. The content is preferably no greater than 0.01 mass % based on the total R-T-B sintered magnet 100. The upper limit for the content is 0.1 mass %, as a range that has virtually no influence on the object and effect of the invention. Thus, the phrase “comprising essentially no heavy rare earth elements” used throughout the present specification includes cases where heavy rare earth elements are included in impurity-level amounts.

The R-T-B sintered magnet 100 may contain about 0.001 to 0.5 mass % of unavoidable impurities such as Mn, Ca, Ni, Si, Cl, S and F, in addition to the elements mentioned above. However, the content of these impurities is preferably less than 2 mass % and more preferably less than 1 mass % in total.

The oxygen content of the R-T-B sintered magnet 100 is preferably 300 to 3000 ppm and more preferably 500 to 1500 ppm, from the viewpoint of achieving an even higher level for the magnetic properties. The nitrogen content of the R-T-B sintered magnet 100 is 200 to 1500 ppm and preferably 500 to 1500 ppm, from the same viewpoint explained above. The carbon content of the R-T-B sintered magnet 100 is 500 to 3000 ppm and preferably 800 to 1500 ppm, from the same viewpoint explained above.

The R-T-B sintered magnet 100 comprises particles containing an R₂T₁₄B phase as the main component. The mean particle diameter of the particles is 0.5 to 5 μm, preferably 2 to 5 μm and more preferably 2 to 4 μm. Thus, the R-T-B sintered magnet 100 contains particles with a small mean particle diameter as the main component, and the structure is fine. In addition, variation in the particle diameters and shapes of the particles is very low. Thus, the R-T-B sintered magnet 100 not only contains particles with small particle diameters but also has low variation in particle diameters and shapes, and therefore the structural homogeneity is sufficiently improved. Consequently, segregation of phases different from the R₂T₁₄B phase, such as an R-rich phase, is minimized. The R-T-B sintered magnet 100 of this embodiment therefore has high magnetic properties. The mean particle diameter of the particles containing the R₂T₁₄B phase in the R-T-B sintered magnet 100 can be determined in the following manner. A cut surface of the R-T-B sintered magnet 100 is polished, and then a metallographic microscope is used for observation of an image of the polished surface. Upon image processing, the particle diameters of the individual particles are measured and the arithmetic mean of the measured values is recorded as the mean particle diameter.

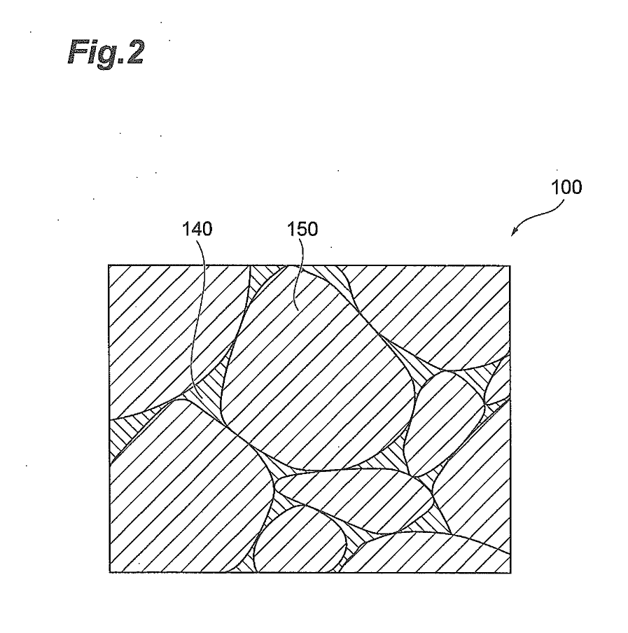

FIG. 2 is a schematic cross-sectional enlarged view showing a portion of a cross-section of the R-T-B sintered magnet of this embodiment.

The crystal grains 150 of the R-T-B sintered magnet 100 preferably comprise an R₂T₁₄B phase. On the other hand, the triple point regions 140 include a phase with a higher R content ratio than the R₂T₁₄B phase, based on mass compared to the R₂T₁₄B phase. The average value of the area of the triple point regions 140 in a cross-section of the R-T-B sintered magnet 100 is no greater than 2 μm² and preferably no greater than 1.9 μm², as the arithmetic mean. Also, the standard deviation for the area distribution is no greater than 3 and preferably no greater than 2.6. Since the R-T-B sintered magnet 100 thus has minimal segregation of the phase with a higher R content than the R₂T₁₄B phase, the area of the triple point regions 140 is low and the variation in area is also reduced. It is thus possible to maintain high levels for both Br and HcJ.

The average value for the area of the triple point regions 140 in the cross-section, and the standard deviation for the area distribution, can be calculated in the following manner. First, the R-T-B sintered magnet 100 is cut and the cut surface is polished. The polished surface image is observed with a scanning electron microscope. Image analysis is performed and the area of the triple point regions 140 is calculated. The arithmetic mean value for the calculated area is the mean area. Also, the standard deviation for the area of the triple point regions 140 can be calculated based on the area of each of the triple point regions 140 and their average value.

The rare earth element content in the triple point regions 140 is preferably 80 to 99 mass %, more preferably 85 to 99 mass % and even more preferably 90 to 99 mass %, from the viewpoint of obtaining an R-T-B sintered magnet with sufficiently high magnetic properties and sufficiently excellent corrosion resistance. From the same viewpoint, the rare earth element contents of each of the triple point regions 140 are preferably equal. Specifically, the standard deviation for the content distribution in the triple point regions 140 of the R-T-B sintered magnet 100 is preferably no greater than 5, preferably no greater than 4 and more preferably no greater than 3.

The R-T-B sintered magnet 100 comprises dendritic crystal grains containing an R₂T₁₄B phase, and grain boundary regions containing a phase with a higher R content than the R₂T₁₄B phase, and preferably it is obtained by molding and firing a ground product of an R-T-B alloy strip having an average value of no greater than 3 μm for the spacing between the phases with a higher R content than the R₂T₁₄B phase in a cross-section. Since such an R-T-B sintered magnet 100 is obtained using a ground product that is sufficiently micronized and has a sharp particle size distribution, it is possible to obtain an R-T-B based sintered compact composed of fine crystal grains. In addition, since the phase with a higher R content than the R₂T₁₄B phase will be present in a higher proportion at the outer periphery than in the interior of the ground product, the state of dispersion of the phase with a higher R content than the R₂T₁₄B phase after sintering will tend to be more satisfactory. Thus, the structure of the R-T-B based sintered compact will be micronized and the homogeneity will be improved. It will thereby be possible to further increase the magnetic properties of the R-T-B based sintered compact.

An R-T-B alloy strip to be used as the starting material for the R-T-B sintered magnet 100 of this embodiment will now be described.

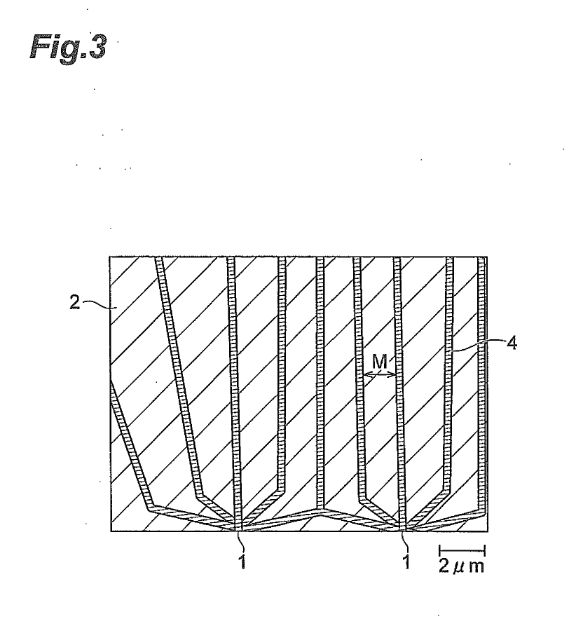

FIG. 3 is a schematic cross-sectional enlarged view showing the cross-sectional structure of an R-T-B alloy strip to be used as the starting material for the R-T-B sintered magnet 100 of this embodiment, along the thickness direction. The R-T-B alloy strip of this embodiment comprises no heavy rare earth elements and contains R₂T₁₄B phase crystal grains 2 as the main phase and a grain boundary phase 4 having a different structure than the R₂T₁₄B phase. The grain boundary phase 4 includes, for example, an R-rich phase. An R-rich phase is a phase with a higher R content than the R₂T₁₄B phase.

As shown in FIG. 3, the R-T-B alloy strip has crystal nuclei 1 on one surface. Also, the crystal nuclei 1 serve as origins from which the crystal grains 2 containing the R₂T₁₄B phase and grain boundary phase 4 extend in a radial fashion toward the other surface. The grain boundary phase 4 is deposited along the grain boundaries of the columnar R₂T₁₄B phase crystal grains 2.

The R-T-B alloy strip used for this embodiment does not have significant spread of the R₂T₁₄B phase crystal grains 2 in the direction perpendicular to the thickness direction (the left-right direction in FIG. 3), in a cross-section along the thickness direction as shown in FIG. 3, but instead they grow essentially uniformly in the thickness direction (the up-down direction in FIG. 3). Consequently, the widths of R₂T₁₄B phase crystal grains 2, i.e. the lengths M in the left-right direction, are smaller compared to a conventional R-T-B alloy strip, and variation in the lengths M is reduced. The widths of the R-rich phase 4, i.e. the lengths in the left-right direction are also small, and variation in the lengths is reduced.

The R-T-B alloy strip to be used for this embodiment satisfies the following inequality (1), where D₁ and D₂ are, respectively, the average value for the lengths of the crystal grains 2 on one (the lower) surface side, in the direction perpendicular to the thickness direction of the R-T-B alloy strip, i.e. the left-right direction in FIG. 3, and the average value for the lengths of the crystal grains 2 on the other (the upper) surface side, in the cross-section shown in FIG. 3.

0.9≦D₂/D₁≦1.1 (1)

Throughout the present specification, D₁, D₂ and D₃ are determined as follows. First, a cross-section such as shown in FIG. 3 is observed by SEM (scanning electron microscope)-BEI (backscattered electron image) (magnification: 1000×). Images are taken of the cross-section in 15 visual fields, on one surface side of the R-T-B alloy strip, on the other surface side, and on the center section. In the images, straight lines are drawn between a location 50 μm on the center section side from the one surface, a location 50 μm on the center section side from the other surface, and the center section. The straight lines are essentially parallel to the one surface and the other surface in the cross-section shown in FIG. 3. The values of D₁, D₂ and D₃ can be determined from the length of the straight line and the number of crystal grains 2 transected by the straight line. D₃ is the average value for the lengths of the crystal grains 2 at the center section in the direction perpendicular to the thickness direction of the R-T-B alloy strip, in a cross-section as shown in FIG. 3.

Since D₂/D₁ for the R-T-B alloy strip used for this embodiment satisfies inequality (1) above, the widths and shapes of the crystal grains 2 have low variation and high homogeneity in the thickness direction. From the viewpoint of further increasing the homogeneity, the value of D₂/D₁ preferably satisfies the following inequality (4) and more preferably satisfies the following inequality (5). The lower limit of D₂/D₁ may be 1.0.

0.95≦D₂/D₁<1.05 (4)

0.98≦D₂/D₁≦1.02 (5)

The R-T-B alloy strip used for this embodiment may be produced by a strip casting method using a cooling roll as described below. In this case, R₂T₁₄B phase crystal nuclei 1 of the R-T-B alloy strip are deposited on the contact surface with the cooling roll (the casting surface). The R₂T₁₄B phase crystal grains 2 grow in a radial fashion from the casting surface side of the R-T-B alloy strip toward the side opposite the casting surface (the free surface). Thus, in the R-T-B alloy strip shown in FIG. 3, the lower surface is the casting surface. In this case, D₁ is the average value for the lengths of the crystal grains 2 on the casting surface side, and D₂ is the average value for the lengths of the crystal grains 2 on the free surface side.

The values of D₁, D₂ and D₃ are, for example, 1 to 4 μm, preferably 1.4 to 3.5 μm, and more preferably 1.5 to 3.2 μm. If the values of D₁, D₂ and D₃ are large, it will tend to be difficult to sufficiently micronize the alloy powder that is obtained by grinding. On the other hand, an R-T-B alloy strip with excessively low values for D₁, D₂ and D₃, while maintaining the crystal grain shapes, will generally be difficult to produce.

The R-T-B alloy strip of this embodiment preferably satisfies the following inequalities (2) and/or (3), where D_{AVE} and D_{MAX} are, respectively, the average value and maximum value for the lengths of the crystal grains 2 in the direction perpendicular to the thickness direction, in the cross-section shown in FIG. 3.

1.0 μm≦D_{AVE}<3.0 μm (2)

1.5 μm≦D_{MAX}≦4.5 μm (3)

Throughout the present specification, D_{AVE} is the average value for D₁, D₂ and D₃ as determined from results of observation of the aforementioned SEM-BEI image (magnification: 1000×), and D_{MAX} is the value for the image with the maximum lengths of the crystal grains 2, among a total of 45 images, taken in 15 visual fields each on one surface side, the other surface side and the center section.

Specifically, inequality (2) specifies that the sizes (widths) of the crystal grains 2 are in a prescribed range, and inequality (3) specifies that the variation in the sizes (widths) of the crystal grains 2 is within a prescribed range. An R-T-B alloy strip satisfying inequalities (2) and (3) is composed of crystal grains 2 that are further micronized and have sufficiently reduced variation in shapes and sizes, and an R-rich phase 4 that is further micronized and has sufficiently reduced variation in shapes and sizes. Consequently, using alloy powder obtained by grinding such an R-T-B alloy strip can yield an R-T-B sintered magnet with further inhibited segregation of the R-rich phase and further increased microstructural homogeneity. If D_{AVE} and D_{MAX} are too small, ultrafine powder will increase during fine grinding, and the amount of oxygen will tend to increase. Also, chill crystals, which are equiaxial crystals, will also increase, and when a sintered magnet is formed the residual flux density (Br) will tend to be lowered.

From the viewpoint of obtaining an R-T-B sintered magnet that is even more micronized and has a uniform structure, D_{AVE} preferably satisfies the following inequality (6). From the same viewpoint, D_{MAX} preferably satisfies the following inequality (7). The R-T-B alloy strip will thus be one that can yield an R-T-B sintered magnet having an even more micronized structure, while also facilitating production of the R-T-B alloy strip.

1.0 μm≦D_{AVE}≦2.4 μm (6)

1.5 μm≦D_{MAX}≦3.0 μm (7)

From the viewpoint of obtaining an R-T-B sintered magnet that has an even more micronized structure and facilitating production of the R-T-B alloy strip, D_{AVE} preferably satisfies the following inequality (8). From the same viewpoint, D_{MAX} preferably satisfies the following inequality (9).

1.5 μm≦D_{AVE}≦2.4 μm (8)

2.0 μm≦D_{MAX}≦3.0 μm (9)

In the cross-section shown in FIG. 3, the proportion of the number of R-rich phases 4 with lengths of no greater than 1.5 μm in the direction perpendicular to the thickness direction, with respect to all of the R-rich phases 4, as phases with a high rare earth element concentration, is preferably 90% or greater, more preferably 93% or greater and even more preferably 95% or greater. By thus increasing the proportion of the number of R-rich phases 4 with lengths of no greater than 1.5 μm among the R-rich phases 4 in the R-T-B alloy strip, it is possible to obtain an R-T-B sintered magnet with even higher coercive force.

The width M of the columnar crystal grains 2 of the R-T-B alloy strip having the cross-section shown in FIG. 3 can be adjusted by altering the molten metal temperature, the surface condition of the cooling roll, the material of the cooling roll, the roll surface temperature and the rotational speed of the cooling roll, and the cooling temperature.

The R-T-B sintered magnet 100 of this embodiment can be produced by the following procedure. The method for producing the R-T-B sintered magnet 100 comprises a melting step in which a molten R-T-B based alloy is prepared, a cooling step in which the molten alloy is poured onto the roll surface of the cooling roll rotating in the circumferential direction, cooling the molten alloy by the roll surface, to obtain an R-T-B alloy strip, a grinding step in which the R-T-B alloy strip is ground to obtain an R-T-B alloy powder, a molding step in which the alloy powder is molded to form a compact, and a firing step in which the compact is fired to obtain an R-T-B sintered magnet.

### (Melting Step)

In the melting step, a starting material comprising at least one rare earth metal or rare earth alloy, or pure iron, ferroboron or an alloy thereof, for example, and containing no heavy rare earth elements, is introduced into a high-frequency melting furnace. In a high-frequency melting furnace, the starting material is heated to 1300° C. to 1500° C. to prepare a molten alloy.

### (Cooling Step)

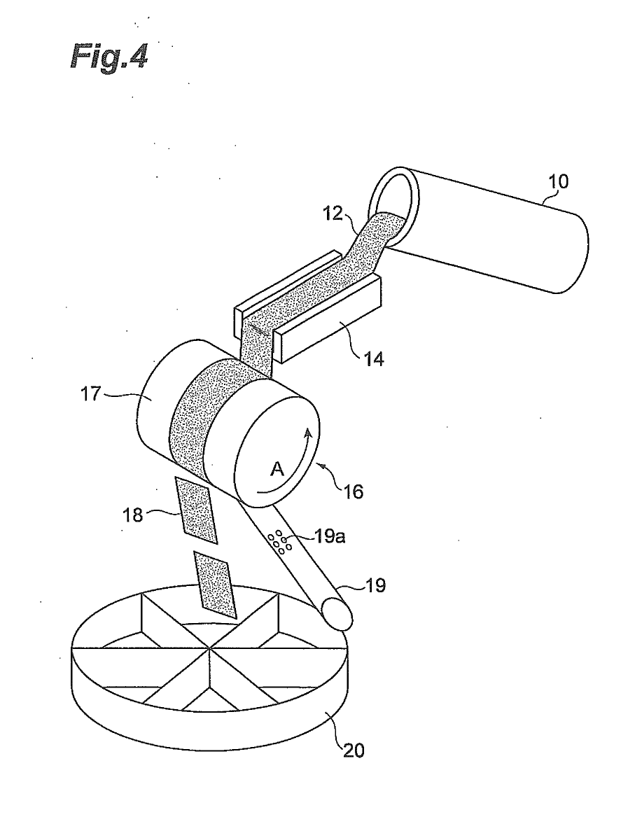

FIG. 4 is a schematic diagram of an apparatus to be used in the cooling step of a strip casting method. In the cooling step, the molten alloy 12 prepared at the high-frequency melting furnace 10 is transferred to a tundish 14. Next, the molten alloy is poured from the tundish 14 onto the roll surface of the cooling roll 16 rotating at a prescribed speed in the direction of the arrow A. The molten alloy 12 contacts with the roll surface 17 of the cooling roll 16 and loses heat by heat exchange. As the molten alloy 12 cools, crystal nuclei are formed in the molten alloy 12 and at least part of the molten alloy 12 solidifies. For example, an R₂T₁₄B phase (melting temperature of about 1100° C.) is formed first, and then at least part of the R-rich phase (melting temperature of about 700° C.) solidifies. The crystal deposition is affected by the structure of the roll surface 17 with which the molten alloy 12 contacts. It is preferred to employ a concavoconvex pattern, comprising mesh-like recesses and raised sections formed by recesses, that has been formed on the roll surface 17 of the cooling roll 16.

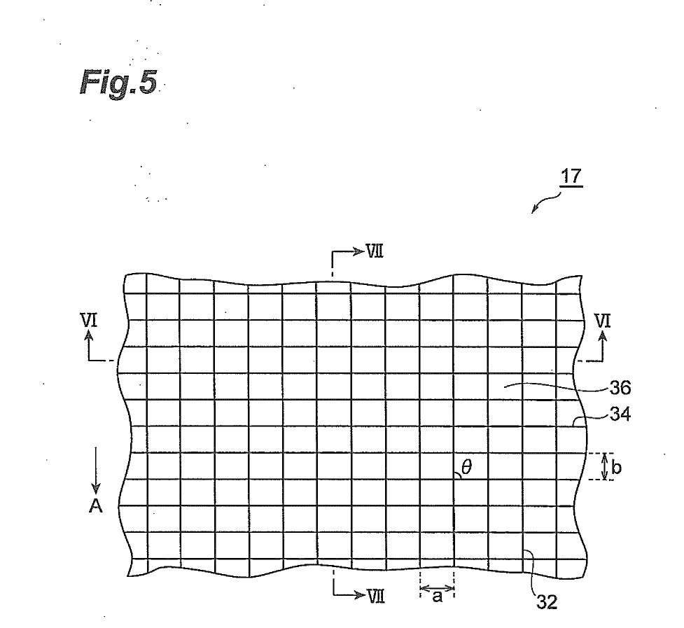

FIG. 5 is a schematic diagram showing a flat enlarged view of part of a roll surface 17. Mesh-like grooves are formed in the roll surface 17, and these form the concavoconvex pattern. Specifically, the roll surface 17 has a plurality of first recesses 32 arranged at a prescribed spacing a along the circumferential direction of the cooling roll 16 (the direction of the arrow A); and a plurality of second recesses 34 arranged essentially perpendicular to the first recesses 32 and at a prescribed spacing b parallel to the axial direction of the cooling roll 16. The first recesses 32 and second recesses 34 are essentially straight linear grooves having prescribed depths. Raised sections 36 are formed by the first recesses 32 and second recesses 34.

The average value for the spacings a and b is preferably 40 to 100 μm. If the average value is too large, the number of crystal nuclei generated during cooling will be too low, and it will tend to be difficult to obtain crystal grains with sufficiently small widths M. However, it is not easy to form recesses 32, 34 having spacings with an average value of 40 μm or smaller.

The surface roughness Rz of the roll surface 17 is preferably 3 to 5 μm, more preferably 3.5 to 5 μm and even more preferably 3.9 to 4.5 μm. If Rz is too large the thickness of the strip will vary, tending to increase variation in the cooling rate, whereas if Rz is too small, adhesiveness between the molten alloy and the roll surface 17 will be insufficient, and the molten alloy or alloy strip will tend to detach from the roll surface earlier than the target time. In this case, the molten alloy migrates to the secondary cooling section without sufficient progression of heat loss of the molten alloy. Therefore, the alloy strips will tend to inconveniently stick together at the secondary cooling section.

The surface roughness Rz, for the purpose of the present specification, is the ten-point height of irregularities and is the value measured according to JIS B 0601-1994. Rz can be measured using a commercially available measuring apparatus (SURFTEST by Mitsutoyo Corp.).

The angle θ formed by the first recesses 32 and second recesses 34 is preferably 80-100° and more preferably 85-95°. By specifying such an angle θ, it will be possible for greater columnar growth of the crystal nuclei of the R₂T₁₄B phase deposited on the raised sections 36 of the roll surface 17 to proceed toward the thickness direction of the alloy strip.

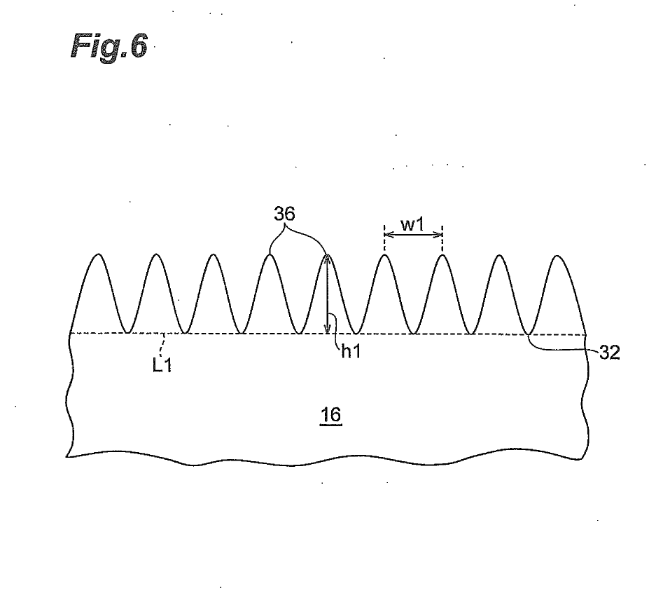

FIG. 6 is a schematic enlarged cross-sectional view showing a cross-section of FIG. 5 along line VI-VI. Specifically, FIG. 5 is a schematic cross-sectional view showing a portion of the cross-sectional structure of a cooling roll 16 cut through the axis on a plane parallel to the axial direction. The heights h1 of the raised sections 36 can be calculated as the shortest distances between the apexes of the raised sections 36 and a straight line L1 passing through the bases of the first recesses 32 and parallel to the axial direction of the cooling roll 16, in the cross-section shown in FIG. 6. Also, the spacing w1 of the raised sections 36 can be calculated as the distance between apexes of adjacent raised sections 36, in the cross-section shown in FIG. 6.

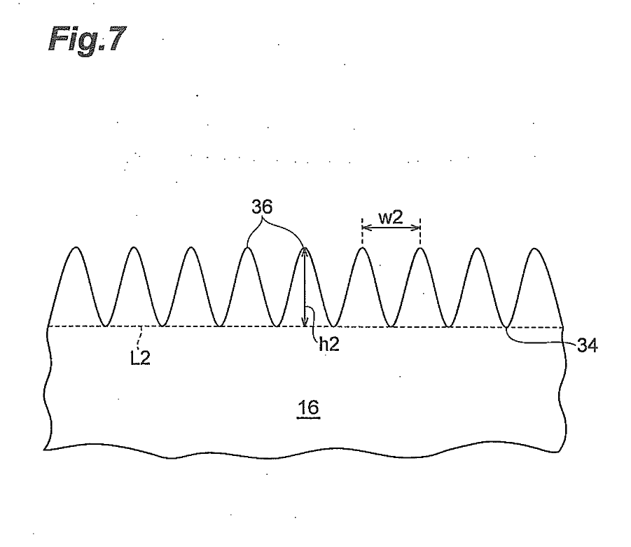

FIG. 7 is a schematic enlarged cross-sectional view showing a cross-section of FIG. 5 along line VII-VII. Specifically, FIG. 7 is a schematic cross-sectional view showing a portion of the cross-sectional structure of a cooling roll 16 cut on a plane parallel to the side. The heights h2 of the raised sections 36 can be calculated as the shortest distances between the apexes of the raised sections 36 and a straight line L2 passing through the bases of the second recesses 34 and perpendicular to the axial direction of the cooling roll 16, in the cross-section shown in FIG. 7. Also, the spacing w2 of the raised sections 36 can be calculated as the distance between apexes of adjacent raised sections 36, in the cross-section shown in FIG. 7.

Throughout the present specification, the average value H of the heights of the raised sections 36 and the average value W of the spacing between raised sections 36 are calculated in the following manner. Using a laser microscope, a profile image (magnification: 200×) was taken of a cross-section of the cooling roll 16 near the roll surface 17, as shown in FIGS. 6 and 7. In these images, 100 points were measured for both heights h1 and heights h2 of arbitrarily selected raised sections 36. Here, measurement was made only for heights h1 and h2 that were 3 μm or greater, including no data for heights of less than 3 μm. The arithmetic mean value of measurement data for a total of 200 points was recorded as the average value for the heights of the raised sections 36.

Also, in the same image, 100 points were measured for both spacings w1 and spacings w2 of arbitrarily selected raised sections 36. Measurement of the spacings was conducted considering only heights h1 and h2 of 3 μm and greater as raised sections 36. The arithmetic mean value of measurement data for a total of 200 points was recorded as the average value W for the spacings of the raised sections 36. When it is difficult to observe a concavoconvex pattern on the roll surface 17 with a scanning electron microscope, a replica may be formed by replicating the concavoconvex pattern of the roll surface 17, and the surface of the replica observed with a scanning electron microscope and measured as described above. A replica can be formed using a commercially available kit (SUMP SET by Kenis, Ltd.).

The concavoconvex pattern of the roll surface 17 can be adjusted by working the roll surface 17 with a short wavelength laser, for example.

The average value H of the heights of the raised sections 36 is preferably 7 to 20 μm. This will cause the recesses 32, 34 to be thoroughly saturated with the molten alloy and allow adhesiveness between the molten alloy 12 and roll surface 17 to be sufficiently increased. The upper limit for the average value H is more preferably 16 μm and even more preferably 14 μm, from the viewpoint of more thoroughly saturating the recesses 32, 34 with the molten alloy. The lower limit for the average value H is more preferably 8.5 μm and even more preferably 8.7 μm, from the viewpoint of obtaining R₂T₁₄B phase crystals with sufficiently high adhesiveness between the molten alloy and the roll surface 17, while also having more uniform orientation in the thickness direction of the alloy strip.

The average value W of the spacing between raised sections 36 is 40 to 100 μm. The upper limit for the average value W is preferably 80 μm, more preferably 70 μm and even more preferably 67 μm, from the viewpoint of further reducing the widths of the R₂T₁₄B phase columnar crystals and obtaining magnet powder with a small particle diameter. The lower limit for the average value W is preferably 45 μm and more preferably 48 μm. This will allow an R-T-B sintered magnet to be obtained having even higher magnetic properties.

For this embodiment, a cooling roll 16 having a roll surface 17 such as shown in FIGS. 5 to 7 is used, and therefore when the molten alloy 12 is poured onto the roll surface 17 of the cooling roll 16, the molten alloy 12 first contacts with the raised sections 36. Crystal nuclei 1 are generated at the contact sections, and the crystal nuclei 1 serve as origins for growth of R₂T₁₄B phase columnar crystals 2. By increasing the number of crystal nuclei 1 per unit area by generation of numerous such crystal nuclei 1, it is possible to minimize growth of the columnar crystals 2 along the roll surface 17.

The role surface 17 of the cooling roll 16 has raised sections 36 that have prescribed heights and have arranged in a prescribed spacing. Numerous R₂T₁₄B phase crystal nuclei 1 are generated on the roll surface 17, after which the columnar crystals 2 grow in a radial fashion with the crystal nuclei 1 as origins. During this time, growth of the columnar crystals 2 proceeds in the thickness direction of the R-T-B alloy strip, forming R₂T₁₄B phase columnar crystals 2 with small widths and low variation in width and shape, and R-rich phases 4 that are even more micronized and have sufficiently reduced variation in shape and size.

The cooling rate can be controlled, for example, by adjusting the temperature or flow rate of cooling water flowing through the interior of the cooling roll 16. The cooling rate can also be adjusted by varying the material of the roll surface 17 of the cooling roll 16.

The cooling rate is preferably 1000° C. to 3000° C./sec and more preferably 1500° C. to 2500° C./sec, from the viewpoint of adequately micronizing the structure of the obtained alloy strip while inhibiting generation of heterophases. If the cooling rate is below 1000° C./sec, an α-Fe phase will tend to be readily deposited, and if the cooling rate exceeds 3000° C./sec, chill crystals will tend to be readily deposited. Chill crystals are isotropic microcrystals with particle diameters of 1 μm and smaller. High generation of chill crystals tends to impair the magnetic properties of the finally obtained R-T-B sintered magnet.

Cooling with the cooling roll may be followed by secondary cooling in which cooling is carried out by a method such as blowing gas. There are no particular restrictions on the method of secondary cooling, and any conventional cooling method may be employed. For example, it may be one provided with a gas tube 19 having a gas blow hole 19a, wherein cooling gas is blown through the gas blow hole 19a onto the alloy strip accumulated on a rotating table 20 rotating in the circumferential direction. The alloy strip 18 can be sufficiently cooled in this manner. The alloy strip is recovered after sufficient cooling with the secondary cooling section 20. It is thus possible to produce an R-T-B alloy strip having a cross-sectional structure such as shown in FIG. 2.

The thickness of the R-T-B alloy strip of this embodiment is preferably no greater than 0.5 mm and more preferably 0.1 to 0.5 mm. If the thickness of the alloy strip becomes too large, the difference in cooling rate will tend to roughen the structure of the crystal grains 2 and impair the homogeneity. Also, the structure near the surface on the roll surface side (the casting surface) and the structure near the surface on the side opposite the casting surface (the free surface) of the alloy strip will differ, and the difference between D₁ and D₂ will tend to increase.

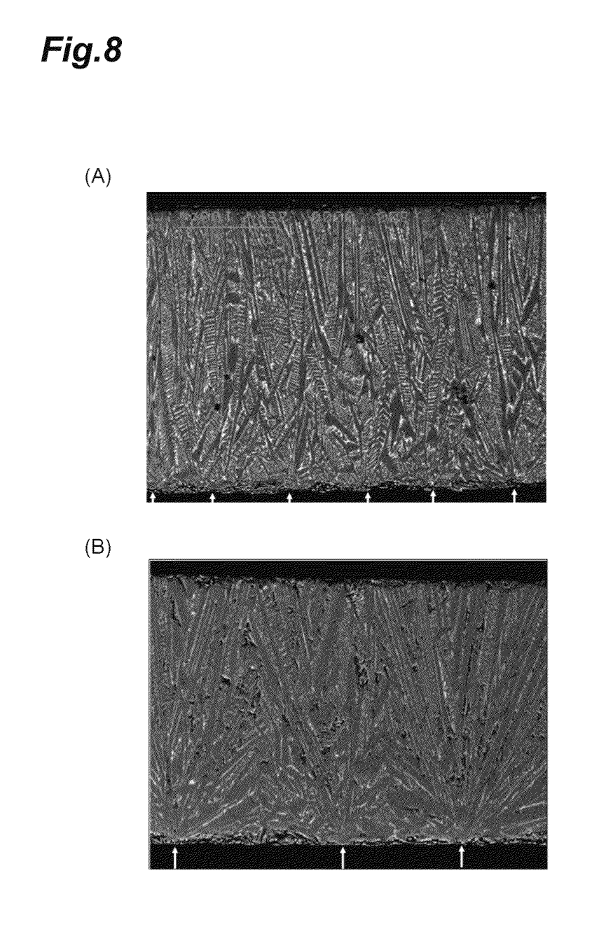

FIG. 8 is an SEM-BEI image showing a cross-section of an R-T-B alloy strip in the thickness direction. FIG. 8(A) is an SEM-BEI image (magnification: 350×) showing a cross-section of the R-T-B alloy strip of this embodiment in the thickness direction. Also, FIG. 8(B) is an SEM-BEI image (magnification: 350×) showing a cross-section of a conventional R-T-B alloy strip in the thickness direction. In FIGS. 8(A) and (B), the lower side surface of the R-T-B alloy strip is the contact surface with the roll surface (casting surface). Also, in FIGS. 8(A) and (B) the deep-colored sections represent R₂T₁₄B phases and the light-colored sections represent R-rich phases.

As shown in FIG. 8(A), the R-T-B alloy strip of this embodiment has the crystal nuclei of numerous R₂T₁₄B phases deposited on the lower surface (see the arrows in the drawing). In addition, R₂T₁₄B phase crystal grains extend in a radial fashion from the crystal nuclei in the upward direction of FIG. 8(A), i.e. along the thickness direction.

On the other hand, as shown in FIG. 8(B), a conventional R-T-B alloy strip has less deposition of R₂T₁₄B phase crystal nuclei than in FIG. 8(A). In addition, the R₂T₁₄B phase crystals grow not only in the up-down direction but also in the left-right direction. Therefore, the lengths (widths) of the R₂T₁₄B phase crystal grains in the direction perpendicular to the thickness direction are increased compared to FIG. 8(A). If the R-T-B alloy strip has such a structure, it will not be possible to obtain alloy powder that is micronized and has excellent homogeneity of shape and size.

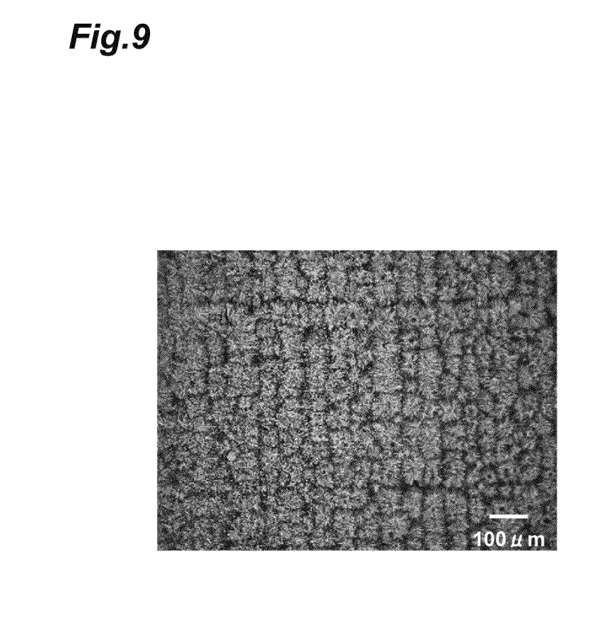

FIG. 9 is a metallographic microscope image (magnification: 100×) of one surface of an R-T-B alloy strip. One surface of the R-T-B metal foil strip in the production method of this embodiment is composed of a plurality of petal-like dendritic crystals containing a R₂T₁₄B phase, as shown in FIG. 9. FIG. 9 is a metallographic microscope image of the surface of the R-T-B alloy strip, taken from the side having crystal nuclei 1 in FIG. 3.

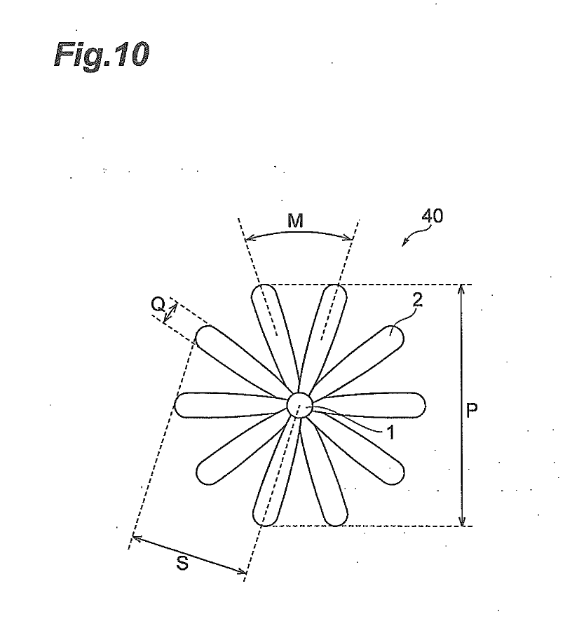

FIG. 10 is an enlarged plan view schematically showing a dendritic crystal composing one surface of an R-T-B alloy strip. The dendritic crystal 40 has a crystal nucleus 1 at the center section, and filler-shaped crystal grains 2 extending in a radial fashion from the crystal nucleus 1 as the origin.

The width P of the dendritic crystal 40 is determined as the maximum distance among the distances between tips of two different filler-like crystal grains 2. Normally, the width P is the distance between the tips of two filler-like crystal grains 2 present at roughly opposite ends across the crystal nucleus 1. Throughout the present specification, the average value for the width P of a dendritic crystal 40 is determined in the following manner. In an image of one surface of the metal foil strip enlarged 200× with a metallographic microscope, 100 dendritic crystals 40 are arbitrarily selected and the width P of each of the dendritic crystals 40 is measured. The arithmetic mean value of the measured values is recorded as the average value for the widths P of the dendritic crystals 40.

The average value for the width P of the dendritic crystal 40 is preferably no greater than 60 μm and more preferably 25 to 60 m. The upper limit for the average value for the width P is preferably 55 μm, more preferably 50 μm and even more preferably 48 μm. This can reduce the sizes of the dendritic crystals 40 and yield even finer alloy powder. The lower limit for the average value of the width P is preferably 30 μm, more preferably 35 nn and even more preferably 38 μm. Growth of the R₂T₁₄B phase in the thickness direction of the alloy strip will thus be even further accelerated. It will thus be possible to obtain alloy powder with small particle diameters and low particle diameter variation.

The surface of the R-T-B alloy strip shown in FIG. 9 has more crystal nuclei 1 per unit area on one surface, and smaller widths P of the dendritic crystals 40, compared to the surfaces of a conventional R-T-B alloy strip. In addition, the spacing M between filler-like crystal grains 2 composing the dendritic crystal 40 is smaller and the sizes of the filler-like crystal grains 2 are also smaller. Specifically, the surface of the R-T-B alloy strip of this embodiment is composed of dendritic crystals 40 that are fine and have limited size variation. The homogeneity of the dendritic crystals 40 is thus significantly improved. Also, the variation in the size of the length S and width Q of filler-like crystal grains 2 on the surface of the R-T-B alloy strip is also significantly reduced.

As shown in FIG. 9, the dendritic crystals 40 lie in one direction overall on one surface of the R-T-B alloy strip, forming a crystal group. If the length of the long axis of the crystal group is represented as C1 and the length of the short axis perpendicular to the long axis is represented as C2, then the average value for the aspect ratio of the crystal group (C2/C1) is preferably 0.7 to 1.0, more preferably 0.8 to 0.98 and even more preferably 0.88 to 0.97. If the aspect ratio is within this range, the homogeneity of the shapes of the dendritic crystals 40 will be increased, and growth of the R₂T₁₄B phase in the thickness direction of the alloy strip will be more uniform. Also, by limiting the widths of the dendritic crystals 40 to within the range specified above, it is possible to obtain an alloy strip that is even more micronized and has a uniformly dispersed R-rich phase. It will thus be possible to obtain alloy powder with small particle diameters and low variation in particle diameter and shape.

For the purpose of the present specification, the average value for the aspect ratio was determined in the following manner. In an image of one surface of the metal foil strip enlarged 200× with a metallographic microscope, 100 crystal groups are arbitrarily selected, and the lengths C1 of the long axes and the lengths C2 of the short axes of each of the crystal groups are measured. The arithmetic mean value for the crystal group ratio (C2/C1) is the average value of the aspect ratio.

For one surface of the R-T-B alloy strip, the number of dendritic crystal nuclei 1 generated is 500 or greater, preferably 600 or greater, more preferably 700 or greater and even more preferably 763 or greater, per 1 mm square. Since the number of crystal nuclei 1 generated is thus high, the size per single crystal nucleus 1 is small, and an R-T-B alloy strip having a micronized structure can be obtained.

The R-T-B alloy strip used for this embodiment may have the structure described above on at least one surface. If at least one surface has such a structure, it will be possible to obtain alloy powder having small particle diameters and a uniformly dispersed R-rich phase.

### (Grinding Step)

There are no particular restrictions on the grinding method in the grinding step. The grinding can be carried out in the order of coarse grinding followed by fine grinding. Coarse grinding is preferably carried out in an inert gas atmosphere using, for example, a stamp mill, jaw crusher, Braun mill or the like. Hydrogen storage grinding may also be carried out, in which grinding is performed after hydrogen has been stored. By coarse grinding it is possible to prepare alloy powder with particle diameters of about several hundred μm. The alloy powder prepared by coarse grinding is subjected to fine grinding to a mean particle diameter of 1 to 5 μm, for example, using a jet mill or the like. Grinding of the alloy strip does not necessarily need to be carried out in two stages of coarse grinding and fine grinding, and may instead be carried out in a single step.

In the grinding step, the sections of the grain boundary phases 4 such as the alloy strip R-rich phase sections preferentially undergo fracturing. Consequently, the particle diameters of the alloy powder depend on the spacing of the grain boundary phase 4. The alloy strip to be used in the method for producing for this embodiment has lower variation in widths of the R₂T₁₄B phase crystal grains than in the prior art, as shown in FIG. 3, and therefore by grinding it is possible to obtain alloy powder having a small particle diameter and sufficiently reduced variation in size and shape.

### (Molding Step)

In the molding step, the alloy powder is molded in a magnetic field to obtain a compact. Specifically, first the alloy powder is packed into a die situated in an electromagnet. A magnetic field is then applied by the electromagnet and the alloy powder is pressed while orienting the crystal axes of the alloy powder. Molding is thus carried out in a magnetic field to prepare a compact. The molding in a magnetic field may be carried out in a magnetic field of 12.0 to 17.0 kOe, for example, at a pressure of about 0.7 to 1.5 ton/cm².

### (Firing Step)

In the firing step, the compact obtained by the magnetic field molding is fired in a vacuum or in an inert gas atmosphere to obtain a sintered compact. The firing conditions are preferably set as appropriate for the conditions including the composition, the grinding method and the particle size. For example, the firing temperature may be set to 1000° C. to 1100° C. for a firing time of 1 to 5 hours.

Since the R-T-B sintered magnet obtained by the production method of this embodiment employs alloy powder comprising highly homogeneous R₂T₁₄B phase crystals and an R-rich phase, it can yield an R-T-B sintered magnet with a more homogeneous structure than the prior art. Consequently, the production method of this embodiment allows production of an R-T-B sintered magnet having sufficiently high coercive force while maintaining residual flux density.

The R-T-B sintered magnet obtained by the process described above may also be subjected to aging treatment if necessary. By carrying out aging treatment, it is possible to further increase the coercive force of the R-T-B sintered magnet. Aging treatment is preferably carried out in two stages, for example, under two different temperature conditions such as near 800° C. and near 600° C. Aging treatment under such conditions will tend to result in particularly excellent coercive force. When aging treatment is carried out in a single step, it is preferably at a temperature of near 600° C.

The R-T-B sintered magnet comprises an R₂T₁₄B phase as the main phase and an R-rich phase as the heterophase. Since the R-T-B sintered magnet is obtained using alloy powder with low variation in shape and particle diameter, it has increased structural homogeneity and sufficiently excellent coercive force.

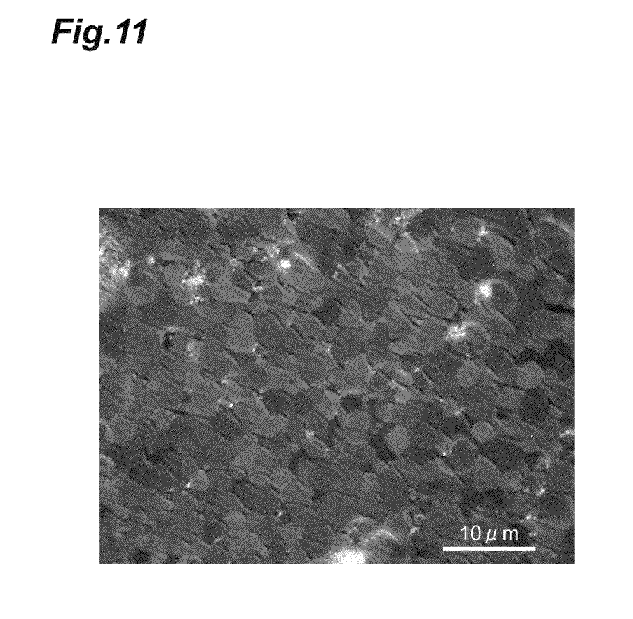

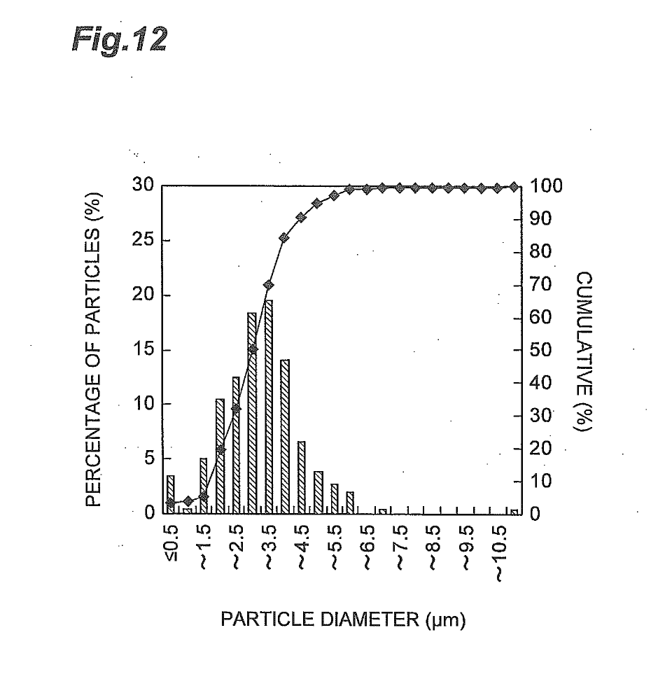

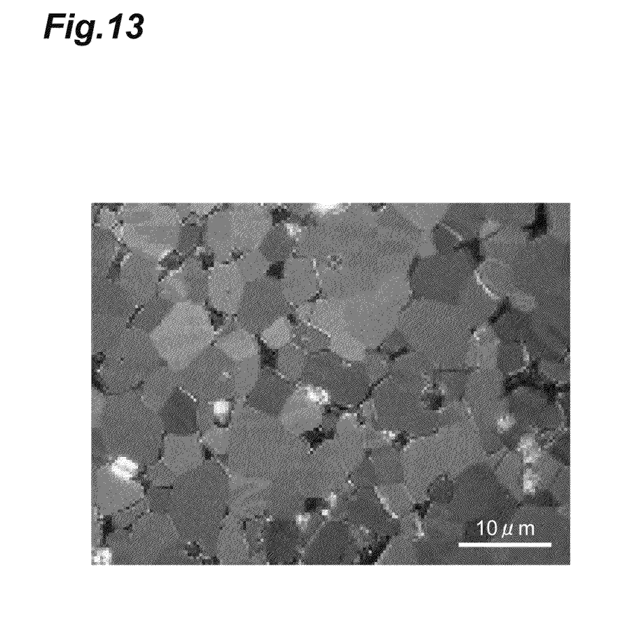

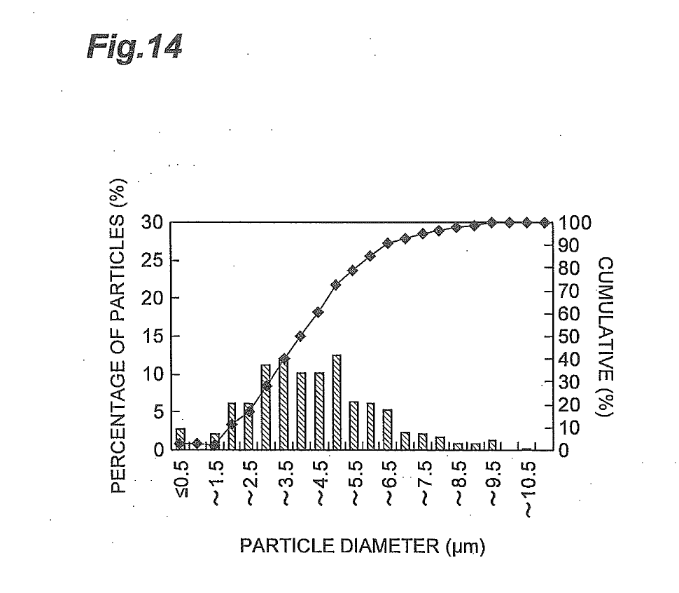

FIG. 11 is a metallographic microscope image (magnification: 1600×) of a cross-section of an R-T-B sintered magnet according to this embodiment. FIG. 12 is a graph showing particle diameter distribution for particles containing a R₂T₁₄B phase in an R-T-B sintered magnet according to this embodiment. FIG. 13 is a metallographic microscope image (magnification: 1600×) of a cross-section of a conventional R-T-B sintered magnet. Also, FIG. 14 is a graph showing particle diameter distribution for particles containing a R₂T₁₄B phase in a conventional R-T-B sintered magnet. The R-T-B sintered magnet of this embodiment, shown in FIGS. 11 and 12, has a finer structure than the prior art, and improved homogeneity of particle diameter and shape. By having such a structure, a high level of magnetic properties and especially high coercive force is realized, even when essentially no Dy is present.

A preferred embodiment of a rotary machine (motor) comprising the R-T-B sintered magnet 110 of this embodiment will now be described.

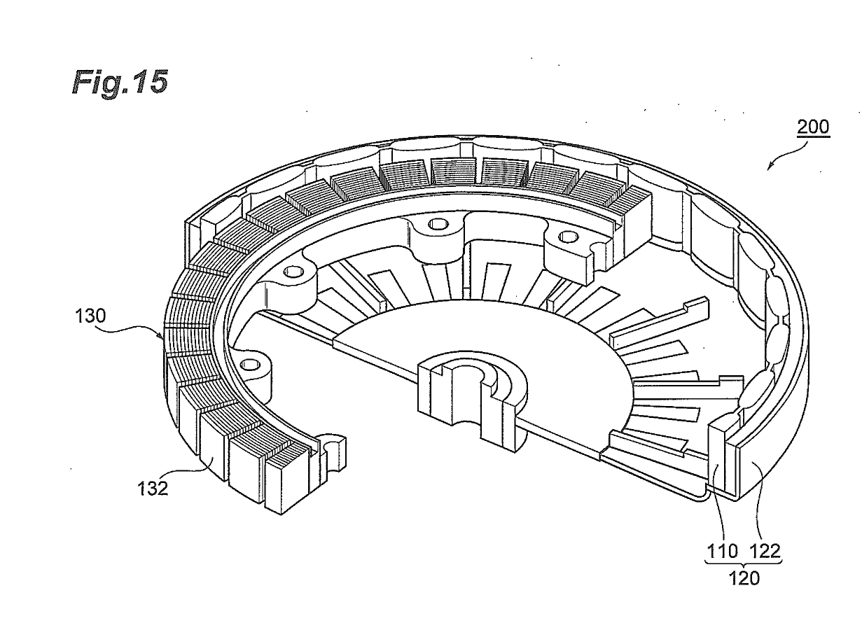

FIG. 15 is an illustration of the internal structure of a motor according to a preferred embodiment. The motor 200 shown in FIG. 15 is a permanent magnet synchronous motor (SPM motor 200), comprising a cylindrical rotor 120 and a stator 130 situated on the inside of the rotor 120. The rotor 120 has a cylindrical core 122 and a plurality of R-T-B sintered magnets 110 oriented with the N-poles and S-poles alternating along the inner peripheral surface of the cylindrical core 122. The stator 130 has a plurality of coils 132 provided along the outer peripheral surface. The coils 132 and R-T-B sintered magnets 110 are arranged in a mutually opposing fashion. The R-T-B sintered magnets 110 each have the same composition and structure as the R-T-B sintered compact 100 described above.

The SPM motor 200 is provided with an R-T-B sintered magnet 110 according to the embodiment described above, in the rotor 120. The R-T-B sintered magnet 110 exhibits high levels in terms of both high magnetic properties and excellent corrosion resistance. Thus, the SPM motor 200 comprising the R-T-B sintered magnet 110 can continuously exhibit high output for prolonged periods.

The embodiment described above is only a preferred embodiment of the invention, and the invention is in no way limited thereto. For example, the R-T-B alloy strip had the crystal nuclei 1 of the R₂T₁₄B phase only on one side, but it may also have the crystal nuclei 1 on the other side of the R-T-B alloy strip. In this case, both sides have crystal nuclei 1 such as shown in FIG. 3, and the crystal grains 2 of the R₂T₁₄B phase extend in a radial fashion along the thickness direction from each of the crystal nuclei 1. Thus, an R-T-B alloy strip having crystal nucli 1 on both sides can be obtained by a twin-roll casting method in which two cooling rolls having the aforementioned concavoconvex pattern are aligned and molten alloy is cast between them.

### EXAMPLES

The nature of the invention will now be further explained through the following examples and comparative examples. However, the invention is not limited to the examples described below.

### Example 1

### Fabrication of Alloy Strip

An apparatus for production of an alloy strip as shown in FIG. 4 was used for a strip casting method by the following procedure. First, the starting compounds for each of the constituent elements were added so that the composition of the alloy strip had the elemental ratios (mass %) shown in Table 1, and heated to 1300° C. with a high-frequency melting furnace 10, to prepare a molten alloy 12 having an R-T-B based composition. The molten alloy 12 was poured onto the roll surface 17 of the cooling roll 16 rotating at a prescribed speed through a tundish. The cooling rate of the molten alloy 12 on the roll surface 17 was 1800° C. to 2200° C./sec.

The roll surface 17 of the cooling roll 16 had a concavoconvex pattern comprising straight linear first recesses 32 extending along the rotational direction of the cooling roll 16, and straight linear second recesses 34 perpendicular to the first recesses 32. The average value H for the heights of the raised sections 36, the average value W for the spacings between the raised sections 36, and the surface roughness Rz, were as shown in Table 2. Measurement of the surface roughness Rz was carried out using a measuring apparatus by Mitsutoyo Corp. (trade name: SURFTEST).

The alloy strip obtained by cooling with the cooling roll 16 was further cooled with a secondary cooling section 20 to obtain an alloy strip having an R-T-B based composition. The composition of the alloy strip was as shown in Table 1.

### <Evaluation of Alloy Strip>

A SEM-BEI image was taken of a cross-section along the thickness direction of the obtained alloy strip (magnification: 350×). The thickness of the alloy strip was determined from the image. The thickness was as shown in Table 2.

In addition, SEM-BEI images of cross-sections along the thickness direction of the alloy strip were for 15 visual fields on the casting surface side, the free surface side and at the center section, for a total of 45 SEM-BEI images (magnification: 1000×). Using the images, 0.15 mm straight lines were drawn to a position 50 μm on the center section side from the casting surface, a position 50 μm on the center section side from the free surface, and to the center section. The values of D₁, D₂ and D₃ were determined from the length of the straight line and the number of crystal grains transected by the straight line.

Incidentally, D₁ is the average value for the lengths of the crystal grains on the casting surface side in the direction perpendicular to the thickness direction, D₂ is the average value for the lengths of the crystal grains on the free surface side in the direction perpendicular to the thickness direction, and D₃ is the average value for the lengths of the crystal grains at the center section in the direction perpendicular to the thickness direction. The average value D_{AVE} was calculated for D₁, D₂ and D₃. Also, D_{MAX} was the value in the image with the maximum crystal grain length among the crystal grain lengths in the direction perpendicular to the thickness direction in the 45 images. The measurement results were as shown in Table 2.

Also, the 45 SEM-BEI images were used to determine the percentage α of the number of R-rich phases with lengths of up to 1.5 μm on the straight line, with respect to the total number of R-rich phases through which the straight line crossed. The results were as shown in Table 2.

The casting surface of the alloy strip was observed with a metallographic microscope, to determine the average value for the widths P of the dendritic crystals, the ratio of the lengths C2 of the short axes with respect to the lengths C1 of the long axes of the dendritic crystal groups (aspect ratio), the area occupancy of the R₂T₁₄B phase crystals with respect to the total visual field, and the number of dendritic crystal nuclei generated per unit area (1 mm²). The results are shown in Table 3. The area occupancy of the R₂T₁₄B phase crystals is the area ratio of dendritic crystals with respect to the total image, in a metallographic microscope image of the casting surface of the R-T-B alloy strip. In FIG. 9, the dendritic crystals correspond to the white sections. The average value for the aspect ratio is the arithmetic mean value for the ratio (C2/C1) for 100 arbitrarily selected crystal groups.

### <Fabrication of R-T-B Sintered Magnet>

The alloy strip was then ground to obtain alloy powder with a mean particle diameter of 2.3 to 2.6 μm. The alloy powder was packed into a die situated in an electromagnet, and molded in a magnetic field to produce a compact. The molding was accomplished by pressing at 1.2 ton/cm² while applying a magnetic field of 15 kOe. The compact was then fired at 930° C. to 1030° C. for 4 hours in a vacuum and rapidly cooled to obtain a sintered compact. The obtained sintered compact was subjected to two-stage aging treatment at 800° C. for 1 hour and at 540° C. for 1 hour (both in an argon gas atmosphere), to obtain an R-T-B sintered magnet for Example 1.

### <Evaluation of R-T-B Sintered Magnet>

A B-H tracer was used to measure the Br (residual flux density) and HcJ (coercive force) of the obtained R-T-B sintered magnet. The measurement results are shown in Table 3. Also, the mean particle diameter was determined for the particles containing the R₂T₁₄B phase in the R-T-B sintered magnet. Specifically, a cut surface of the R-T-B sintered magnet was polished, and then a metallographic microscope was used for observation of an image of the polished surface (magnification: 1600×). Also, upon image processing, the particle diameters of the individual particles were measured and the arithmetic mean of the measured values was recorded as the mean particle diameter. The values of the mean particle diameters are shown in Table 3.

### Examples 2 to 6, Examples 15 to 17

R-T-B sintered magnets for Examples 2 to 6 and Examples 15 to 17 were obtained in the same manner as Example 1, and evaluated, except that the roll surface of the cooling roll was worked to change the average value H for the heights of the raised sections, the average value W for the spacings between the raised sections and the surface roughness Rz, as shown in Table 2, and the structure of the R-T-B alloy strip was changed as shown in Tables 2 and 3. The results are shown in Table 3.

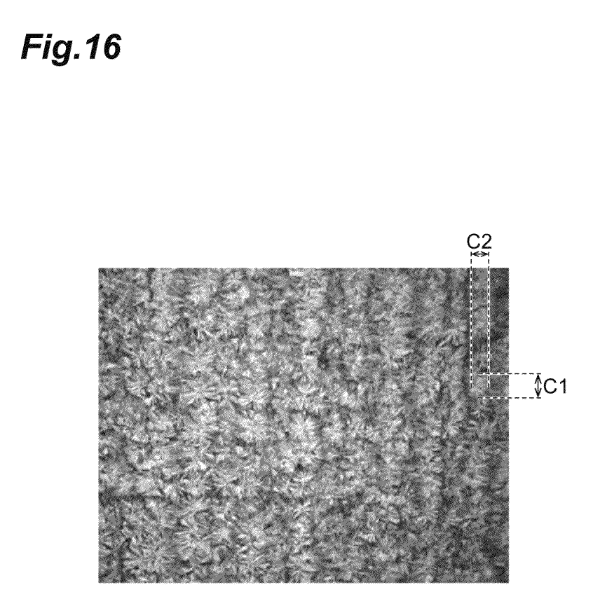

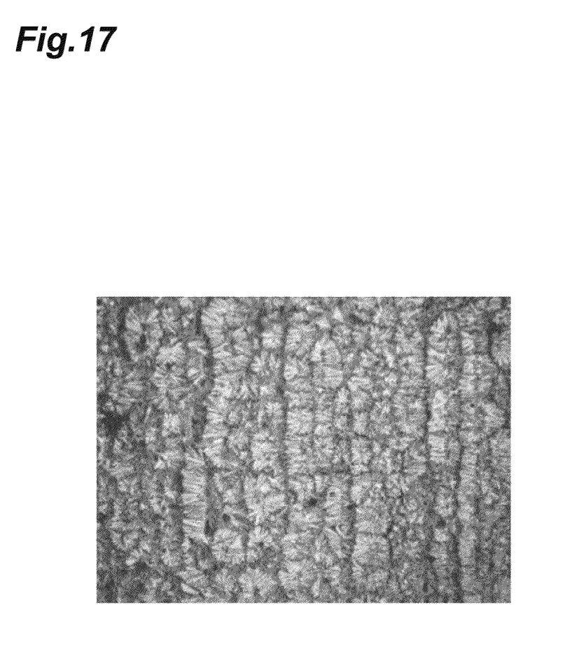

FIG. 16 is a metallographic microscope image (magnification: 100×) of one surface of the R-T-B alloy strip used in Example 1. FIG. 17 is a metallographic microscope image (magnification: 100×) of one surface of the R-T-B alloy strip used in Example 2. Based on these metallographic microscope images, it was confirmed that the R-T-B alloy strip used in each of the examples had the dendritic R₂T₁₄B phase crystal grains on the surface, with generation of numerous crystal nuclei. FIG. 16 shows the lengths C1 of the long axes and the lengths C2 of the short axes of the dendritic crystal groups. The ratio of C2 to C1 is the aspect ratio. Table 3 shows the arithmetic mean values for the aspect ratio.

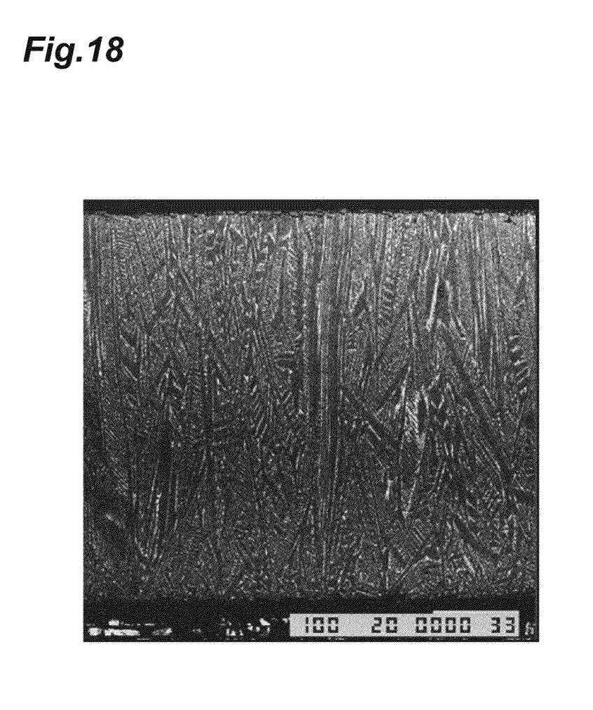

FIG. 18 is an SEM-BEI image (magnification: 350×) of a cross-section of the R-T-B alloy strip of Example 5, along the thickness direction. FIG. 11 is an optical microscope image of a cross-section of the R-T-B sintered magnet of Example 5, and FIG. 12 is a graph showing particle diameter distribution for R₂T₁₄B phase particles in the cross-section. As clearly seen from FIGS. 11 and 12, it was confirmed that the particle diameters of the crystal grains of the R-T-B sintered magnet of Example 5 were sufficiently small and the variation in particle diameter and shape was low. This is because, as shown in FIG. 18, an R-T-B alloy strip was used comprising R₂T₁₄B phase crystal grains with minimal diffusion in the direction perpendicular to the thickness direction, in a cross-section along the thickness direction. In other words, by using such an R-T-B alloy strip, variation in the particle diameters and shapes of the alloy powder obtained by grinding is sufficiently reduced, and it is therefore possible to obtain an R-T-B sintered magnet with increased homogeneity of structure.

### Examples 7 to 14 and Examples 18 to 22

R-T-B sintered magnets for Examples 7 to 14 and Examples 18 to 22 were obtained in the same manner as Example 1, and evaluated, except that the roll surface of the cooling roll was worked to change the average value for the heights of the raised sections, the average value for the spacings between the raised sections and the surface roughness Rz, as shown in Table 2, and the starting materials were changed to change the compositions of the alloy strip as shown in Table 1. The results are shown in Table 3.

### Comparative Example 1

An R-T-B alloy strip was obtained for Comparative Example 1 in the same manner as Example 1, except that there were used cooling rolls having only straight linear first recesses on the roll surfaces extending in the rotational direction of the rolls, and the structure of the R-T-B alloy strip was changed as shown in Tables 2 and 3. These cooling rolls did not have second recesses. The average value H for the heights of the raised sections, the average value W for the spacings between the raised sections and the surface roughness Rz, for the cooling rolls, were determined in the following manner. Specifically, the cross-sectional structure near the roll surface was observed with a scanning electron microscope at the cut surface, when the cooling roll was cut on a plane parallel to the axial direction running through the axis of the cooling roll. The average value H for the heights of the raised sections is the arithmetic mean value for the heights of 100 raised sections, and the average value W for the spacings between the raised sections is the arithmetic mean value for the values of spacings between adjacent raised sections measured at 100 different locations.

The alloy strip of Comparative Example 1 was evaluated in the same manner as Example 1. An R-T-B sintered magnet for Comparative Example 1 was fabricated in the same manner as Example 1 and evaluated. The results are shown in Table 3.

### Comparative Examples 2 and 3

R-T-B sintered magnets for Comparative Examples 2 and 3 were obtained in the same manner as Example 1, and evaluated, except that the roll surface of the cooling roll was worked to change the average value H for the heights of the raised sections, the average value W for the spacings between the raised sections and the surface roughness Rz, as shown in Table 2. The results are shown in Table 3.

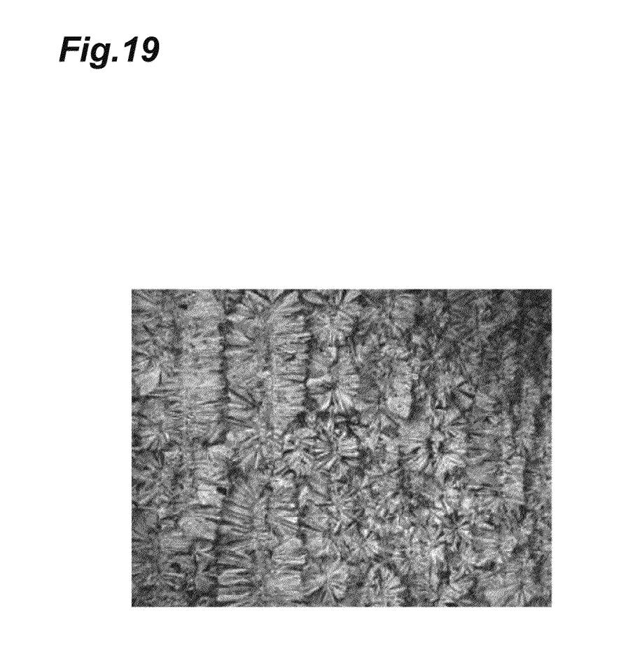

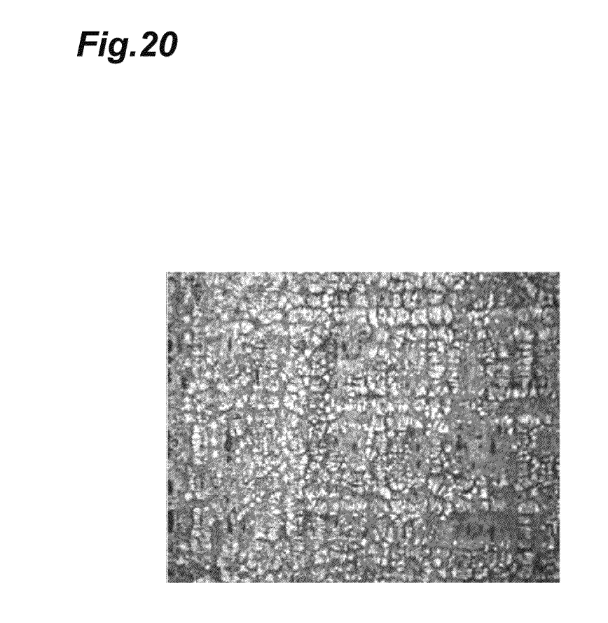

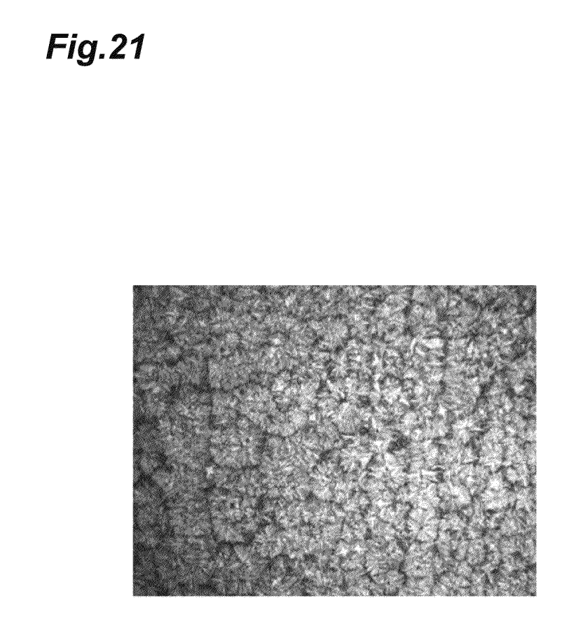

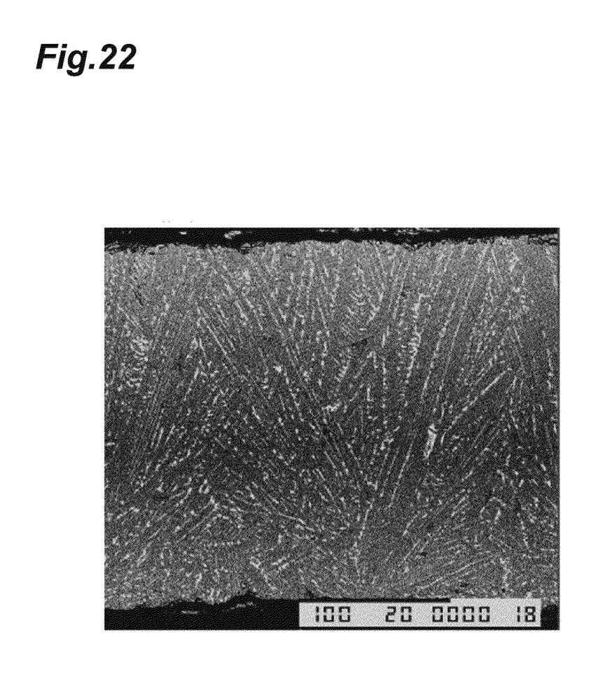

FIGS. 19, 20 and 21 are each metallographic microscope images (magnification: 100×) of one surface of the R-T-B alloy strips used in Comparative Example 1, 2 and 3, respectively. FIG. 22 is an SEM-BEI image (magnification: 350×) of a cross-section of the R-T-B alloy strip used in Comparative Example 3, along the thickness direction. Based on the metallographic microscope images of FIGS. 19 to 21 it was confirmed that either dendritic crystal grains were not formed on the surfaces of the R-T-B alloy strips used in the comparative examples, or even if formed, the individual crystal nuclei were large and non-homogeneous.

### Comparative Examples 4 and 5

An R-T-B alloy strip was obtained for each of Comparative Examples 4 and 5 in the same manner as Example 1, except that the starting materials were changed to change the compositions of the alloy strips as shown in Table 1, there were used cooling rolls having only straight linear first recesses on the roll surfaces extending in the rotational direction of the rolls, and the structure of the R-T-B alloy strip was changed as shown in Tables 2 and 3. These cooling rolls did not have second recesses. The average value H for the heights of the raised sections, the average value W for the spacings between the raised sections and the surface roughness Rz, for the cooling rolls, were determined in the same manner as Comparative Example 1. The alloy strips of Comparative Examples 4 and 5 were evaluated in the same manner as Example 1. R-T-B sintered magnets for Comparative Examples 4 and 5 were fabricated in the same manner as Example 1 and evaluated. The results are shown in Table 3.

TABLE 1

| | Contents of elements in R-T-B alloy strip, based on mass (mass %) | | | | | | | | | |
|---|---|---|---|---|---|---|---|---|---|---|
| | Nd | Pr | Dy | Co | Cu | Al | Ga | Zr | B | Fe |
| Examples 1-6, | 31.00 | 0.00 | 0.00 | 1.00 | 0.10 | 0.20 | 0.00 | 0.20 | 0.98 | 66.52 |
| Comp. Exs. 1-3, | | | | | | | | | | |
| Examples 15-17 | | | | | | | | | | |
| Example 7 | 32.50 | 0.00 | 0.00 | 1.00 | 0.10 | 0.20 | 0.00 | 0.20 | 0.98 | 65.02 |
| Example 8 | 34.00 | 0.00 | 0.00 | 1.00 | 0.10 | 0.20 | 0.00 | 0.20 | 0.98 | 63.52 |
| Example 9 | 34.70 | 0.00 | 0.00 | 1.00 | 0.10 | 0.20 | 0.00 | 0.20 | 0.98 | 62.82 |
| Example 10 | 25.00 | 6.00 | 0.00 | 0.50 | 0.10 | 0.20 | 0.10 | 0.20 | 1.00 | 66.90 |
| Example 11 | 31.20 | 0.00 | 0.00 | 1.00 | 0.10 | 0.20 | 0.10 | 0.10 | 1.02 | 66.28 |
| Example 12 | 28.10 | 3.10 | 0.00 | 1.10 | 0.10 | 0.20 | 0.10 | 0.10 | 0.98 | 66.22 |
| Example 13 | 22.40 | 8.90 | 0.00 | 1.00 | 0.10 | 0.20 | 0.00 | 0.10 | 0.99 | 66.31 |
| Example 14 | 28.30 | 5.80 | 0.00 | 0.50 | 0.20 | 0.10 | 0.30 | 0.20 | 1.03 | 63.57 |
| Example 18 | 34.00 | 0.00 | 0.00 | 1.00 | 0.10 | 0.20 | 0.00 | 0.20 | 1.03 | 63.47 |
| Example 19 | 29.50 | 0.00 | 0.00 | 0.50 | 0.10 | 0.20 | 0.00 | 0.06 | 0.90 | 68.74 |
| Example 20 | 29.50 | 0.00 | 0.00 | 0.50 | 0.20 | 0.20 | 0.00 | 0.20 | 0.91 | 68.49 |
| Example 21 | 28.30 | 0.00 | 0.00 | 1.00 | 0.10 | 0.20 | 0.00 | 0.20 | 1.10 | 69.10 |
| Example 22 | 28.30 | 0.00 | 0.00 | 2.80 | 0.10 | 0.20 | 0.00 | 0.20 | 1.00 | 67.40 |
| Comp. Ex. 4 | 23.20 | 5.80 | 2.10 | 1.00 | 0.10 | 0.20 | 0.00 | 0.20 | 1.00 | 66.40 |
| Comp. Ex. 5 | 25.00 | 6.00 | 0.00 | 0.50 | 0.10 | 0.20 | 0.10 | 0.20 | 1.00 | 66.90 |

Units of values in the table are mass %. Values for Fe include unavoidable impurities.

TABLE 2

| | Cooling roll surface | | | | Alloy | | | | | | | |
|---|---|---|---|---|---|---|---|---|---|---|---|---|
| | | Surface | Raised section | Raised section | strip | Cross-section along thickness | | | | | | |
| | Concavo- | roughness | height | spacing | Thick- | direction of alloy strip | | | | | | Percent- |
| | convex | (Rz) | (mean value H) | (mean value W) | ness | D_{AVE} | D_{MAX} | D₁ | D₂ | D₃ | | age α |
| | pattern | μm | μm | μm | mm | μm | μm | μm | μm | μm | D₂/D₁ | % |
| Example 1 | perpendicular | 4.2 | 7.0 | 66 | 0.30 | 2.95 | 3.91 | 2.96 | 3.05 | 2.84 | 1.03 | 91 |
| Example 2 | perpendicular | 4.5 | 9.0 | 64 | 0.29 | 2.47 | 3.23 | 2.45 | 2.54 | 2.43 | 1.03 | 93 |
| Example 3 | perpendicular | 3.9 | 11.6 | 60 | 0.27 | 2.36 | 2.75 | 2.30 | 2.42 | 2.37 | 1.05 | 95 |
| Example 4 | perpendicular | 4.1 | 11.6 | 57 | 0.25 | 2.17 | 2.81 | 2.14 | 2.19 | 2.17 | 1.02 | 95 |
| Example 5 | perpendicular | 4.4 | 13.0 | 54 | 0.23 | 2.00 | 2.59 | 1.97 | 2.00 | 2.04 | 1.02 | 97 |
| Example 6 | perpendicular | 4.5 | 14.0 | 48 | 0.18 | 1.76 | 2.18 | 1.67 | 1.84 | 1.76 | 1.10 | 93 |
| Example 7 | perpendicular | 4.3 | 8.5 | 65 | 0.23 | 2.05 | 2.45 | 1.95 | 2.12 | 2.08 | 1.09 | 93 |
| Example 8 | perpendicular | 4.2 | 8.7 | 63 | 0.23 | 1.77 | 2.19 | 1.69 | 1.85 | 1.77 | 1.09 | 93 |
| Example 9 | perpendicular | 4.4 | 9.2 | 67 | 0.23 | 1.56 | 1.94 | 1.49 | 1.63 | 1.55 | 1.09 | 94 |
| Example 10 | perpendicular | 4.4 | 10.2 | 62 | 0.26 | 2.36 | 3.03 | 2.23 | 2.42 | 2.42 | 1.09 | 93 |
| Example 11 | perpendicular | 4.3 | 10.5 | 57 | 0.24 | 2.41 | 3.14 | 2.28 | 2.48 | 2.48 | 1.09 | 93 |
| Example 12 | perpendicular | 4.3 | 10.4 | 58 | 0.25 | 2.28 | 2.90 | 2.17 | 2.35 | 2.31 | 1.08 | 94 |
| Example 13 | perpendicular | 4.3 | 9.9 | 57 | 0.23 | 2.32 | 2.88 | 2.21 | 2.43 | 2.33 | 1.10 | 92 |
| Example 14 | perpendicular | 4.4 | 10.7 | 57 | 0.23 | 2.22 | 2.78 | 2.12 | 2.30 | 2.23 | 1.08 | 94 |
| Example 15 | perpendicular | 4.6 | 6.8 | 66 | 0.30 | 2.95 | 3.81 | 2.80 | 3.08 | 2.96 | 1.10 | 91 |
| Example 16 | perpendicular | 4.7 | 14.2 | 47 | 0.17 | 1.50 | 1.92 | 1.48 | 1.50 | 1.53 | 1.01 | 98 |
| Example 17 | perpendicular | 4.4 | 7.2 | 65 | 0.30 | 2.90 | 3.72 | 2.81 | 3.04 | 2.84 | 1.08 | 91 |
| Example 18 | perpendicular | 4.4 | 10.2 | 60 | 0.26 | 2.31 | 3.09 | 2.15 | 2.50 | 2.50 | 1.09 | 92 |
| Example 19 | perpendicular | 4.3 | 10.3 | 62 | 0.27 | 2.52 | 3.22 | 2.30 | 2.64 | 2.52 | 1.09 | 93 |
| Example 20 | perpendicular | 4.4 | 10.2 | 61 | 0.27 | 2.45 | 3.10 | 2.24 | 2.60 | 2.57 | 1.09 | 93 |
| Example 21 | perpendicular | 4.2 | 10.1 | 59 | 0.26 | 2.80 | 3.57 | 2.49 | 2.83 | 2.94 | 1.09 | 92 |
| Example 22 | perpendicular | 4.4 | 10.2 | 59 | 0.28 | 2.78 | 3.42 | 2.39 | 2.77 | 2.88 | 1.09 | 91 |
| Comp. Ex. 1 | Rotational | 2.9 | 5.8 | 126 | 0.29 | 4.32 | 5.52 | 4.02 | 4.57 | 4.38 | 1.14 | 85 |
| | direction | | | | | | | | | | | |
| Comp. Ex. 2 | perpendicular | 5.8 | 16.9 | 35 | 0.31 | 4.78 | 6.23 | *1 | 4.66 | 5.12 | un- | 86 |
| | | | | | | | | | | | measurable | |
| Comp. Ex. 3 | perpendicular | 3.2 | 6.7 | 70 | 0.19 | 4.10 | 5.26 | 3.70 | 4.39 | 4.21 | 1.19 | 82 |
| Comp. Ex. 4 | Rotational | 2.1 | 3.3 | 172 | 0.24 | 4.82 | 6.13 | 4.41 | 4.98 | 5.20 | 1.13 | 78 |
| | direction | | | | | | | | | | | |
| Comp. Ex. 5 | Rotational | 2.8 | 5.3 | 132 | 0.33 | 4.98 | 6.03 | 4.38 | 5.07 | 4.88 | 1.16 | 80 |
| | direction | | | | | | | | | | | |

*1: Unmeasurable due to generation of chill crystals instead of columnar crystal grains.

TABLE 3

| | Alloy strip surface | | | | Sintered magnet | | |
|---|---|---|---|---|---|---|---|
| | Crystal width P | Number of crystal | Crystal group | Area | Mean | Magnetic properties | |
| | (mean value) | nuclei generated | aspect ratio | occupancy | particle size | Br | Hcj |
| | μm | (no./mm²) | (mean value) | (%) | (μm) | (kG) | (kOe) |
| Example 1 | 48 | 763 | 0.88 | 93 | 3.25 | 14.0 | 16.4 |
| Example 2 | 47 | 820 | 0.90 | 95 | 3.27 | 14.1 | 16.7 |
| Example 3 | 42 | 948 | 0.91 | 93 | 3.12 | 13.9 | 17.5 |
| Example 4 | 42 | 1028 | 0.94 | 94 | 3.22 | 13.9 | 18.1 |
| Example 5 | 42 | 903 | 0.90 | 90 | 2.98 | 13.8 | 18.8 |
| Example 6 | 38 | 1028 | 0.97 | 85 | 3.24 | 13.7 | 16.7 |
| Example 7 | 44 | 949 | 0.90 | 95 | 3.41 | 13.8 | 17.5 |
| Example 8 | 42 | 1008 | 0.90 | 94 | 3.34 | 13.0 | 19.8 |
| Example 9 | 45 | 1023 | 0.90 | 95 | 3.27 | 12.6 | 20.6 |
| Example 10 | 44 | 843 | 0.94 | 93 | 3.32 | 13.9 | 16.5 |
| Example 11 | 45 | 865 | 0.93 | 93 | 3.25 | 14.0 | 16.7 |
| Example 12 | 40 | 902 | 0.95 | 95 | 3.43 | 14.1 | 16.4 |
| Example 13 | 41 | 920 | 0.93 | 94 | 3.22 | 14.0 | 16.3 |
| Example 14 | 42 | 908 | 0.93 | 94 | 3.86 | 13.2 | 18.2 |
| Example 15 | 50 | 768 | 0.82 | 92 | 3.43 | 14.4 | 15.0 |
| Example 16 | 38 | 1008 | 0.93 | 95 | 3.13 | 13.5 | 18.0 |
| Example 17 | 51 | 794 | 0.83 | 91 | 3.39 | 14.4 | 15.4 |
| Example 18 | 42 | 879 | 0.93 | 93 | 3.76 | 13.4 | 18.1 |
| Example 19 | 47 | 840 | 0.92 | 92 | 3.32 | 15.0 | 15.6 |
| Example 20 | 44 | 833 | 0.93 | 91 | 3.36 | 13.9 | 15.8 |
| Example 21 | 52 | 782 | 0.94 | 88 | 3.80 | 13.9 | 15.2 |
| Example 22 | 50 | 788 | 0.94 | 90 | 3.83 | 14.0 | 14.5 |
| Comp. Ex. 1 | 110 | 685 | 0.68 | 80 | 3.26 | 13.8 | 13.8 |
| Comp. Ex. 2 | 20 | 435 | 0.93 | 31 | 3.51 | 13.6 | 12.5 |
| Comp. Ex. 3 | 62 | 768 | 0.94 | 93 | 3.47 | 13.8 | 14.0 |
| Comp. Ex. 4 | 131 | 572 | 0.63 | 72 | 3.68 | 13.5 | 19.1 |
| Comp. Ex. 5 | 124 | 585 | 0.65 | 76 | 3.65 | 13.8 | 12.5 |

Based on the results shown in Table 3, it was confirmed that the R-T-B sintered magnets of Examples 1 to 22 have excellent coercive force without containing essentially any heavy rare earth elements such as Dy, Tb and Ho, and have coercive force equivalent to Comparative Example 4 which contains Dy.

### [Structural Analysis of R-T-B Sintered Magnets]

### (Area and Standard Deviation for Triple Point Regions)

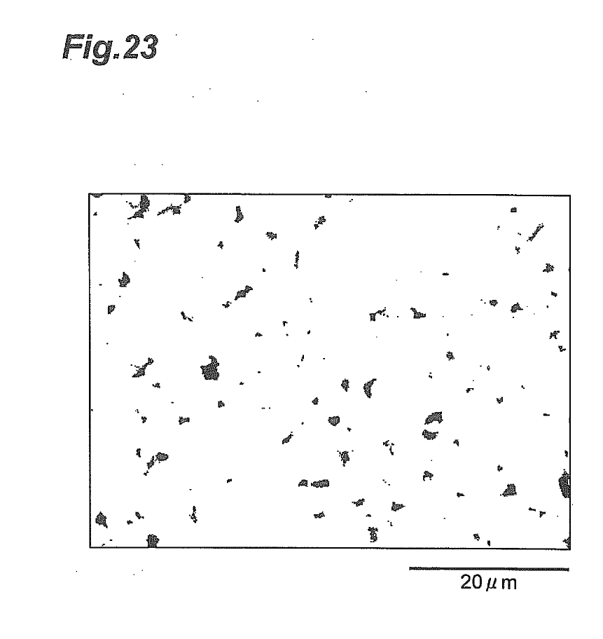

For the R-T-B sintered magnet of Example 10 there was used an electron beam microanalyzer (EPMA: JXA8500F Model FE-EPMA), and element map data were collected. The measuring conditions were: an acceleration voltage of 15 kV, an irradiation current of 0.1 μA and a count-time of 30 msec, the data acquisition region was X=Y=51.2 μm, and the number of data points was X=Y=256 (0.2 μm-step). In the element map data, first triple point regions surrounded by 3 or more crystal grains are colored black, and by image analysis thereof, the average value for the area of the triple point regions and the standard deviation for the area distribution were calculated. FIG. 23 is a diagram showing element map data for the rare earth sintered magnet of Example 10, with the triple point regions indicated in black.

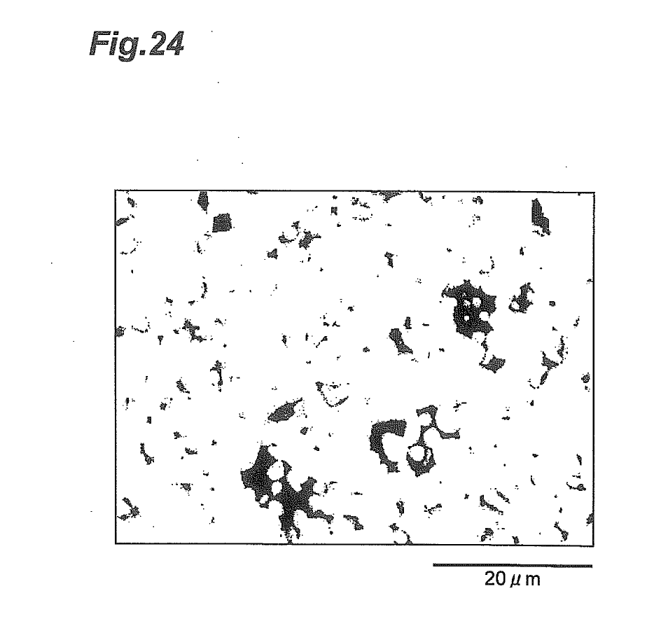

The EPMA was used for structural observation of the R-T-B sintered magnets of Example 5, Example 9, Examples 11 to 14, Examples 18 to 22, Comparative Example 4 and Comparative Example 5, in the same manner as the R-T-B sintered magnet of Example 10. FIG. 24 is a diagram showing element map data for the R-T-B sintered magnet of Comparative Example 5, with the triple point regions indicated in black.

Each of the examples and comparative examples was subjected to image analysis in the same manner as Example 10, and the average value for the area of the triple point regions and the standard deviation for the area distribution were calculated. The results are shown in Table 4. As shown in Table 4, the R-T-B sintered magnets of the examples had sufficiently smaller values for the average value and standard deviation for the area of the triple point regions, compared to the comparative examples. These results confirmed that in the examples, segregation of the phase with a higher R content than the R₂T₁₄B phase was sufficiently inhibited.

### (Rare Earth Element Content of Triple Point Regions)

An EPMA was used to determine the mass contents of rare earth elements in the triple point regions of the R-T-B sintered magnets of the examples and comparative examples. The measurement was conducted for 10 triple point regions, and the range and standard deviation for the rare earth element content was determined. The results are shown in Table 4.

### (Oxygen, Nitrogen and Carbon Contents)

A common gas analysis apparatus was used for gas analysis of the R-T-B sintered magnets of the examples and comparative examples, and the oxygen, nitrogen and carbon contents were determined. The results are shown in Table 4.

TABLE 4

| | | | Rare earth elements of | | | | |
|---|---|---|---|---|---|---|---|
| | Triple point region area | | triple point regions | | Oxygen | Nitrogen | Carbon |
| | Mean value | | Content | | content | content | content |
| | (μm²) | S.D. | (mass %) | S.D. | (ppm) | (ppm) | (ppm) |
| Example 5 | 1.7 | 2.2 | 91-98 | 2.6 | 570 | 530 | 1080 |
| Example 9 | 1.9 | 1.9 | 93-98 | 2.9 | 1200 | 890 | 1400 |
| Example 10 | 1.2 | 1.1 | 92-98 | 2.4 | 590 | 560 | 1100 |
| Example 11 | 1.8 | 2.6 | 91-98 | 2.7 | 890 | 820 | 950 |
| Example 12 | 1.5 | 2.3 | 92-98 | 2.5 | 780 | 780 | 1020 |
| Example 13 | 1.7 | 2.1 | 91-98 | 2.8 | 650 | 870 | 980 |
| Example 14 | 1.9 | 1.7 | 93-98 | 2.6 | 1420 | 1010 | 1380 |
| Example 18 | 1.9 | 1.7 | 92-98 | 2.6 | 1410 | 1020 | 1390 |
| Example 19 | 1.7 | 2.0 | 90-98 | 2.8 | 680 | 860 | 980 |
| Example 20 | 1.6 | 2.1 | 91-98 | 2.7 | 690 | 870 | 1000 |
| Example 21 | 1.2 | 1.3 | 92-98 | 2.5 | 580 | 590 | 1060 |
| Example 22 | 1.1 | 1.5 | 91-98 | 2.4 | 570 | 550 | 1080 |
| Comp. Ex. 4 | 1.8 | 2.6 | 91-98 | 2.8 | 660 | 640 | 1200 |
| Comp. Ex. 5 | 3.4 | 7.1 | 82-98 | 5.7 | 800 | 760 | 1380 |

As shown in Tables 3 and 4, although Example 10 and Comparative Example 5 both used alloy powder having about the same mean particle diameter, the R-T-B sintered magnet obtained in Example 10 had a higher HcJ value. This is presumably because the R-T-B sintered magnet of Example 10 not only had a finer crystal grain particle diameter, but also had more uniform particle diameters and shapes of the crystal grains, and therefore reduced segregation of the triple point regions.

### INDUSTRIAL APPLICABILITY

According to the invention it is possible to provide an R-T-B sintered magnet having sufficiently excellent coercive force without using expensive and scarce heavy rare earth elements, as well as a method for its production.

### EXPLANATION OF SYMBOLS

1: Crystal nuclei, 2: crystal grain (columnar crystal), 4: grain boundary phase (R-rich phase), 10: high-frequency melting furnace, 12: molten alloy, 14: tundish, 16: cooling roll, 17: roll surface, 18: alloy strip, 19: gas tubing, 19a: gas blow hole, 20: table, 32, 34: recesses, 36: raised section, 40: dendritic crystal, 100, 100: R-T-B sintered magnets, 120: rotor, 122: core, 130: stator, 132: coil, 140: triple point region, 150: crystal grain, 200: motor.

1. An R-T-B sintered magnet comprising:
particles containing an R₂T₁₄B phase, the R-T-B sintered magnet being obtained using an R-T-B alloy strip containing crystal grains of an R₂T₁₄B phase,
wherein the R-T-B alloy strip has, in a cross-section along the thickness direction,
the crystal grains extending in a radial fashion from the crystal nuclei, the following inequality (1) being satisfied where the average value of the lengths of the crystal grains on one side in the direction perpendicular to the thickness direction and the average value of the lengths on the other side opposite the one side are represented as D₁ and D₂, respectively,
the mean particle diameter of the particles is 0.5 to 5 μm, and essentially no heavy rare earth elements are present;
0.9≦D₂/D₁≦1.1 (1)
with the proviso that R represents a light rare earth element, T represents a transition element, and B represents boron.

2. The R-T-B sintered magnet according to claim 1, wherein the R-T-B alloy strip satisfies the following inequalities (2) and (3), where D_{AVE} and D_{MAX} are, respectively, the average value and maximum value for the lengths of the crystal grains in the direction perpendicular to the thickness direction in the cross section;
1.0 μm≦D_{AVE}<3.0 μm (2)
1.5 μm≦D_{MAX}≦4.5 μm (3).

3. The R-T-B sintered magnet according to claim 1, wherein the R-T-B alloy strip contains R-rich phases in which the R content is higher than the R₂T₁₄B phases based on mass, and in the cross-section, the percentage of the number of the R-rich phases with lengths of no greater than 1.5 μm in the direction perpendicular to the thickness direction with respect to the total number of the R-rich phases being 90% or greater.

4. The R-T-B sintered magnet according to claim 1,
wherein the crystal grains of the R-T-B alloy strip are dendritic crystals, and
on at least one surface of the R-T-B alloy strip, the average value for the widths of the dendritic crystals is no greater than 60 μm and the number of dendritic crystal nuclei is at least 500 per 1 mm square area.

5. A rotary machine comprising an R-T-B sintered magnet according to claim 1.

6. A method for production of an R-T-B sintered magnet comprising particles containing an R₂T₁₄B phase, the method comprising a step of grinding, molding and firing an R-T-B alloy strip containing crystal grains of an R₂T₁₄B phase,
wherein the R-T-B alloy strip has, in a cross-section along the thickness direction,
the crystal grains extending in a radial fashion from the crystal nuclei, the following inequality (1) being satisfied where the average value of the lengths of the crystal grains on one side in the direction perpendicular to the thickness direction and the average value of the lengths on the other side opposite the one side are represented as D₁ and D₂, respectively,
the mean particle diameter of the particles is 0.5 to 5 mm, and essentially no heavy rare earth elements are present;
0.9≦D₂/D₁≦1.1 (1)
with the proviso that R represents a light rare earth element, T represents a transition element, and B represents boron.
